(19) United States
(12) Patent Application Publication
(10) Pub. No.: US 2025/0247914 A1
(43) Pub. Date: Jul. 31, 2025

(54) LAYER1/LAYER2 TRIGGERED MOBILITY INTERWORKING WITH CELL DTX/DRX AT TARGET CELL

(71) Applicant: Subramanya CHANDRASHEKAR

(72) Inventor: Subramanya CHANDRASHEKAR

(21) Appl. No.: 18/702,223

(22) PCT Filed: Dec. 27, 2023
(86) PCT No.: PCT/US2023/086003

§ 371 Date: Apr. 17, 2024

(51) Int. Cl. H04W 76/28; H04W 24/08; H04W 24/10; H04W 36/08; H04W 52/02; H04W 76/27

(52) U.S. Cl. CPC H04W 76/28; H04W 24/08; H04W 24/10; H04W 36/08; H04W 76/27; H04W 52/02

(57) ABSTRACT

Example embodiments of the present disclosure relate to Layer 1/Layer 2 (L1/L2) Triggered Mobility (LTM) interworking with Cell Discontinuous Transmission (DTX)/Discontinuous Reception (DRX) at a target cell. According to one or more embodiments, a system may include a distributed unit (DU) that may be configured to determine, based on an active duration of a Cell DTX/DRX cycle associated with an inter-frequency cell, an optimal measurement gap (MG). Further, the DU may be configured to provide, to a user equipment (UE), information of the optimal MG, wherein the information of the optimal MG may be utilized by the UE to perform an inter frequency measurement.

### CROSS REFERENCE TO RELATED APPLICATION

This application claims priority from Indian Provisional Patent Application No. 202341052487, filed with the Indian Patent Office on Aug. 4, 2023, and entitled “SYSTEM AND METHOD FOR LAYER 1/2 TRIGGERED MOBILITY INTERWORKING WITH CELL DTX/DRX AT TARGET CELL”, the disclosure of which is incorporated herein by reference in its entirety.

### TECHNICAL FIELD

Example embodiments of the present disclosure relate to Layer 1/Layer 2 (L1/L2) Triggered Mobility (LTM) interworking with Cell Discontinuous Transmission (DTX)/Discontinuous Reception (DRX) at a target cell.

### BACKGROUND

In order to enhance the performance of a telecommunication network, various features and mechanisms have been introduced. Among others, one or more technical specifications provided by 3rd Generation Partnership Project (3GPP) standard organization (e.g., Release 18, etc.) have described mechanisms and procedures for Layer 1/Layer 2 (L1/L2) Triggered Mobility (LTM) to reduce mobility latency. Further, one or more 3GPP technical specifications (e.g., Release 18, etc.) have also described the concepts and mechanisms for Cell Discontinuous Transmission (DTX)/Discontinuous Reception (DRX) for network energy saving. A user equipment (UE) may be configured with LTM to reduce mobility latency and may perform an LTM cell switch to a target cell, while the target cell may be configured with Cell DTX/DRX for energy-saving purposes.

### SUMMARY

Example embodiments of the present disclosure provide systems, apparatuses, methods, and the like, that facilitate LTM interworking with Cell DTX/DRX at a target cell.

According to one or more embodiments, a system may include a distributed unit (DU) that may be configured to determine, based on an active duration of a Cell Discontinuous Transmission (DTX)/Discontinuous Reception (DRX) cycle associated with an inter-frequency cell, an optimal measurement gap (MG). Further, the DU may be configured to provide, to a user equipment (UE), information of the optimal MG, wherein the information of the optimal MG may be utilized by the UE to perform an inter frequency measurement.

According to one or more embodiments, a method may include: determining, based on an active duration of a Cell DTX/DRX cycle associated with an inter-frequency cell, an optimal MG; and providing, to a UE, information of the optimal MG, wherein the information of the optimal MG may be utilized by the UE to perform an inter frequency measurement.

According to one or more embodiments, a non-transitory computer-readable recording medium may have recorded thereon instructions executable by at least one network node to cause the at least one network node to perform a method. The method may include: determining, based on an active duration of a Cell DTX/DRX cycle associated with an inter-frequency cell, an optimal MG; and providing, to a UE, information of the optimal MG, wherein the information of the optimal MG may be utilized by the UE to perform an inter frequency measurement.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of example Cell DTX/DRX cycles;

FIG. 2 illustrates a block diagram of a generic system architecture in which one or more example embodiments may be implemented;

FIG. 3 illustrates a flow diagram of an example method for providing an optimal MG of an inter-frequency cell during an LTM preparation phase, according to one or more embodiments;

FIG. 4 illustrates a flow diagram of an example method for performing an inter-frequency measurement during an LTM preparation phase, according to one or more embodiments;

FIG. 5 illustrates a flow diagram of an example method for preparing at least one inter-frequency LTM candidate cell during an LTM preparation phase, according to one or more embodiments;

FIG. 6 illustrates a flow sequence of a first example use case of an LTM preparation phase that involves the operations in the methods of FIG. 3 to FIG. 5, according to one or more embodiments;

FIG. 7 illustrates a flow sequence of a second example use case of an LTM preparation phase that involves the operations in the methods of FIG. 3 to FIG. 5, according to one or more embodiments;

FIG. 8 illustrates a flow diagram of an example method for utilizing at least one UL grant to receive at least one notification of a successful LTM cell switch during an LTM execution phase, according to one or more embodiments;

FIG. 9 illustrates a flow diagram of an example method for providing at least one notification of a successful LTM cell switch during an LTM execution phase, according to one or more embodiments;

FIG. 10A and FIG. 10B illustrate a flow sequence of an example use case of an LTM execution phase that involves the operations in the methods of FIG. 8 and FIG. 9, according to one or more embodiments;

FIG. 11 illustrates a block diagram of example components of a network node, according to one or more embodiments;

FIG. 12 illustrates a block diagram of an example configuration of a network node, according to one or more embodiments; and

FIG. 13 illustrates a diagram of an example environment in which the systems and/or methods described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, and the like. For instance, the terms “Cell DTX/DRX”, “LTM cell switch”, “MAC CE”, “PDCCH”, “RRC Reconfiguration message”, and the like, as well as the associated features and operations, are to be interpreted as consistent with those specified in one or more 3GPP technical specifications and the like, unless being described otherwise.

Further, although some embodiments of the present disclosure may be described herein with reference to “gNodeB” of 5G system and the associated components, it can be understood that the scope of the present disclosure should not be limited thereto. Specifically, example embodiments of the present disclosure may also apply to any suitable network elements in any suitable telecommunication system, such as a 4G LTE system, a 6G system, and the like.

In addition, although it is described herein that a central unit (CU) may communicate with a user equipment (UE), it can be understood that such descriptions do not necessarily restrict that the CU is directly connecting or communicating with the UE. Rather, it is contemplated that the CU may communicate with the UE via any suitable channel or element, such as via a distributed unit (DU), a network cell, and the like, without departing from the scope of the present disclosure. Similarly, although it is described herein that DU may communicate with the UE, it can be understood that such descriptions do not necessarily restrict that the DU is directly connecting or communicating with the UE, due to a similar reason.

Furthermore, the terms “Cell DTX/DRX” are intended to specify that the “DTX/DRX” is associated with a network cell. In this regard, it is contemplated that although some example embodiments may be described herein with reference to “Cell DTX/DRX”, said example embodiments may be similarly applied to only “Cell DTX” or only “Cell DRX”, without departing from the scope of the present disclosure.

In addition, in the descriptions of some embodiments, different labeling or terms may apply to a cell under different stages, conditions, or phases. For instance, a cell to which a device (e.g., a user equipment (UE), etc.) is connected may be referred to as a “serving cell” (or a “source cell”), a cell nearby the serving cell or the device may be referred to as a “neighboring cell”, a neighboring cell that may be selected as a potential cell for LTM cell switch and for which an LTM configuration may be sent to the device may be referred to as a “candidate cell” (or an “LTM candidate cell”), and a candidate cell that is selected for the LTM cell switch may be referred to as a “target cell” (or an “LTM target cell”). Further, a DU that serves or hosts the cell may also be described with different labeling or terms under different stages, conditions, or phases, in a similar manner.

With the evolvement in telecommunication network technologies, network elements in a telecommunication network may be disaggregated into multiple entities. Specifically, a disaggregated architecture, defined in one or more 3GPP technical specifications, disaggregates a base station into multiple logical entities. For instance, a gNodeB (gNB) may be disaggregated into a Central Unit (CU) and a Distributed Unit (DU). Likewise, a single CU may be disaggregated into a CU-Control Plane (CU-CP) and a CU-User Plane (CU-UP).

The CU-CP may host the Radio Resource Control (RRC) layer and PDCP-c, and the CU-UP may host the Service Data Adaptation Protocol (SDAP) layer and PDCP-u. In this regard, PDCP-c may refer to a first mode of the Packet Data Convergence Protocol (PDCP) layer that primarily handles control plane data, and PDCP-u may refer to a second mode of the PDCP layer that primarily handles user plane data. On the other hand, a single DU may host or serve multiple network cells, a Radio Link Control (RLC) layer, a Media Access Control (MAC) layer, and a Physical (PHY) layer. The scheduling operation may take place at the DU.

The concepts and basic principles of Layer 1/Layer 2 (L1/L2)-Triggered Mobility (LTM) have been introduced in one or more 3GPP technical specifications (e.g., Release-18). Generally, LTM is a procedure in which a base station (e.g., gNB) receives one or more L1 measurements (e.g., in the form of one or more L1 measurement reports, etc.) from a UE, and triggers a cell switch procedure based on the received L1 measurement(s). Specifically, the base station may change the UE's serving cell by signaling, to the UE, a Media Access Control (MAC) Control Element (CE) that includes a cell switch command. Accordingly, the UE may switch from the serving cell to a target cell according to the cell switch command.

By way of example, when a UE is configured with LTM, the UE may continuously monitor one or more parameters (e.g., radio signal quality, signal strength, etc.) of one or more nearby candidate cells and/or the serving cell. Accordingly, the UE may report one or more L1 measurements to the serving cell (or a base station associated therewith), and the serving cell (or the base station associated therewith) may evaluate, based on the one or more L1 measurements, whether or not one or more cell switch criteria have been satisfied. For instance, the serving cell (or the base station associated therewith) may determine, based on one or more parameters in the one or more L1 measurements, whether or not the signal quality of the serving cell is deteriorating or whether or not a neighboring candidate cell offers a better signal quality. Based on determining that one or more cell switch criteria have been satisfied, the serving cell (or the base station associated therewith) may send, to the UE, a MAC CE including a cell switch command, instructing the UE to perform an LTM cell switch from the serving cell to the target cell.

To this end, the LTM enables a cell switch via L1/L2 signaling, without involving or affecting the upper layers (e.g., Layer 3, etc.). Further, LTM leverages L1 measurement(s) to trigger or initiate an optimized cell switch procedure, thereby facilitating seamless cell switch and mobility management for a UE when the UE moves between different cells or access points in the telecommunication network.

On the other hand, the mechanisms and procedures for Cell Discontinuous Transmission (DTX)/Discontinuous Reception (DRX) have also been described in one or more 3GPP technical specifications (e.g., Release 18, etc.). Generally, Cell DTX/DRX is designed to optimize the power consumption of a network cell by allowing the network cell to periodically enter sleep mode and wake-up mode according to pre-defined cycles.

By configuring a cell with Cell DTX/DRX, the cell can enter into sleep mode for a period of time, and then wake up to transmit and/or receive data thereafter. Specifically, when the cell is configured with Cell DTX/DRX, the cell can get into sleep mode for a period of time and then wake up again to transmit/receive data (if any), which in turn effectively reduces the power consumption of the cell. The cell configured with Cell DTX/DRX may periodically repeat the entering of sleep mode and wake-up mode, and a cycle of such phenomena may be referred to as a “Cell DTX/DRX cycle”.

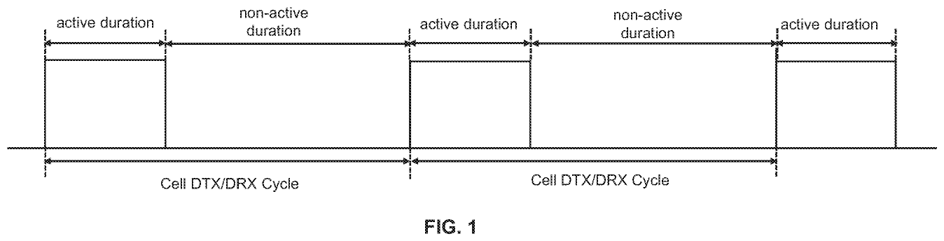

FIG. 1 illustrates a diagram of examples of the Cell DTX/DRX cycle. As illustrated in FIG. 1, a DRX cycle may define the periodic repetition of an “active duration” followed by a “non-active duration”. The x-axis of the diagram may define the length of the Cell DTX/DRX cycles (e.g., in ms, etc.), while the y-axis of the diagram may define the level of power consumption when the cell turns on during the active duration. The Cell DTX/DRX pattern or configuration (e.g., length of Cell DTX/DRX cycle, length of active duration, etc.) may be defined and adjustable by an operator of the network.

During the “active duration”, a cell configured with the Cell DTX/DRX can be turned on and then enter the wake-up mode. Conversely, during the “non-active duration”, the cell can be turned off and then enter the sleep mode. Thus, in some implementations, an “active duration” may also be referred to as an “on-duration”, and a “non-active duration” may also be referred to as an “off-duration”.

Further, in some implementations, a device (e.g., a user equipment, etc.) may be provided or configured with a Cell DTX/DRX pattern. When Cell DTX is configured and activated for a cell, the device does not monitor the physical downlink control channel (PDCCH) and/or the Semi-Persistent Scheduling (SPS) occasions during the Cell DTX non-active duration. Conversely, when Cell DRX is configured and activated for the cell, the UE does not transmit on configured grant (CG) resources or a scheduling request (SR) during the Cell DRX non-active duration. Thus, the “active duration” of a Cell DTX/DRX cycle may refer to a duration that the device (e.g., UE) waits for to receive data from the cell (e.g., PDCCH and/or SPS occasions, etc.), and transmit SR or CG. The active duration and cycle parameters may be common between Cell DTX and Cell DRX, when both the Cell DTX and Cell DRX are configured or activated. During the “active duration”, the transmission/reception of PDCCH, SPS, CG, Scheduling Request (SR), periodic and semi-persistent CSI report, and the like, are not impacted for the purpose of network energy saving.

During the active duration, the cell configured with Cell DTX/DRX can enter into the wake-up mode (e.g., with the RF module turned on, etc.) and can determine whether or not there is any data for transmission and/or reception. If the cell detects data for transmission and/or reception, the cell may stay awake and start the data transmission and/or reception. On the other hand, if the cell does not detect any data for transmission and/or reception within the active duration, the cell may enter into sleep mode during the non-active duration. In some implementations, during the non-active duration, instead of disabling all transmission/reception, the cell may disable particular transmission/reception, thereby providing limited transmission/reception. For example, the cell may be configured such that no transmission and/or reception of particular periodic signals and/or channels (e.g., common channels/signals, UE-specific signals/channels, etc.) is enabled during the non-active duration. Ultimately, configuring a cell with Cell DTX/DRX enables the cell to conserve power consumption.

In view of the above, a base station (e.g., gNB) may configure a candidate cell/a target cell with Cell DTX/DRX and may provide LTM configuration to a UE such that the UE may be configured with LTM, thereby enhancing the performance of the cell and the UE. Nevertheless, in the related art, there are several shortcomings when the candidate cell/target cell is configured with Cell DTX/DRX and the UE is configured with the LTM.

Specifically, when the UE is configured with LTM and the Cell DTX/DRX is enabled in the candidate cell(s)/target cell, the operations of the LTM cell switch may involve different phases, such as a preparation phase and an execution phase. Each of the phases may experience challenges in facilitating effective LTM interworking with Cell DTX/DRX.

During the preparation phase of the LTM cell switch (which may also be referred to as an “LTM preparation phase”), the UE may be requested (e.g., by the base station) to perform one or more measurements on one or more inter-frequency cells. For instance, the UE may need to perform one or more L3 measurements on one or more inter-frequency cells and provide the same to the base station, and the base station may prepare one or more candidate cells from among the one or more inter-frequency cells based thereon.

In order to perform a measurement on an inter-frequency cell, the UE is required to obtain and utilize the information of a measurement gap (MG) associated with said inter-frequency cell. In the related art, the MG is determined/selected based on the configuration provided by the base station, and is then provided to the UE along with information for inter-frequency measurement (e.g., Cell ID of an inter-frequency cell to which the measurement should be performed, etc.). As further described below, the MG defines a measurement duration/window in which the UE temporarily stops any ongoing data transmission/reception and focuses on the measurement of the inter-frequency cell.

In this regard, if the Cell DTX/DRX is activated at the inter-frequency cell (i.e., the potential candidate/target cell), the provided MG may be suboptimal or insufficient for performing an effective measurement. For instance, if the UE is attempting to perform measurement on the inter-frequency cell during the non-active duration of the Cell DTX/DRX cycle of the inter-frequency cell (i.e., when the inter-frequency is in sleep mode), the UE may not be able to measure the inter-frequency cell and need to wait until the upcoming active duration of the Cell DTX/DRX cycle of the inter-frequency cell. In this case, if the provided MG is smaller than required, the UE may not be able to perform effective measurements on the inter-frequency cell. In a scenario when the MG is smaller than the non-active duration of the Cell DTX/DRX cycle and is overlapping with said non-active duration, the UE may simply spend the measurement duration waiting for the upcoming active duration, without being able to perform measurement thereon.

Accordingly, the approaches in the provisioning of MG in the related art may not be efficient and effective when the cells involved in the LTM preparation phase are configured with Cell DTX/DRX. Specifically, there is a possibility that the reporting of inter-frequency measurements (that is required by the base station in preparing the candidate cells for an LTM cell switch) would be delayed, which in turn delays the LTM preparation phase and causes ineffective and inefficient LTM procedures.

Next, during the execution phase of the LTM cell switch (which may also be referred to as an “LTM execution phase”), the UE may perform an LTM cell switch with or without involving Random Access Channel (RACH) procedures. In the following, the LTM cell switch that requires the RACH procedures may be referred to as “RACH-based LTM cell switch” herein, and the LTM cell switch that does not require the RACH procedures may be referred to as “RACH-less LTM cell switch” herein.

If the UE has not yet obtained the timing advance (TA) of the target cell (or if the obtained TA has expired) when being instructed to perform the LTM cell switch, the UE may perform the RACH-based LTM cell switch by performing RACH procedures with the allocated RACH resources.

On the other hand, if the UE has obtained the TA of the target cell when being instructed to perform the LTM cell switch, the UE may perform the RACH-less LTM cell switch. In this regard, the UE should send a first uplink (UL) data packet to the target cell/target DU (i.e., the new serving cell/new serving DU) as the indication of a successful LTM cell switch, as described in the 3GPP technical specification (e.g., RAN2, etc.). However, if the Cell DTX/DRX is activated/enabled at the target cell, the UE would not be able to send the UL data packet to indicate the successful LTM cell switch during the non-active duration, and the UE would need to wait until the active duration in the next Cell DTX/DRX cycle in order to send the UL data packet.

As a result, in the related art, if the LTM cell switch processes involve a target cell that is configured with the Cell DTX/DRX, the network may not timely know if the UE has successfully or unsuccessfully performed an LTM cell switch. In some cases, if the UL data packet indicating the successful cell switch is not timely received by the target cell/target DU, the network may assume that the LTM cell switch was unsuccessful and the UE may be instructed to perform another LTM cell switch, or even be switched back to the old serving cell (such phenomenon may be referred to as a “ping-pong phenomenon”).

In addition to the shortcomings described above, the mechanism for facilitating interworking among LTM and Cell DTX/DRX at the target cell, in the disaggregated architecture, remains unclear and unspecified at the present time. For instance, it is unclear how the entities in a disaggregated gNB (e.g., gNB-CU, gNB-DU, etc.) operate to enable proper execution of LTM when a target cell is configured with Cell DTX/DRX.

In this regard, example embodiments of the present disclosure provide a system architecture, mechanism, procedure, and the like, for facilitating LTM interworking with Cell DTX/DRX at the target cell, thereby enabling proper execution of LTM when the target cell is configured with DTX/DRX.

Specifically, example embodiments of the present disclosure provide a system, a method, a device, and the like, that provide at least one optimal measurement gap (MG) to a UE, thereby enabling the UE to efficiently and effectively perform inter-frequency measurement(s) on an inter-frequency cell(s), even if the inter-frequency cell(s) is configured with Cell DTX/DRX. Ultimately, example embodiments of the present disclosure enable an efficient and effective LTM preparation phase, even if the candidate/target cell(s) involved in the LTM preparation phase is configured with Cell DTX/DRX.

Further, example embodiments of the present disclosure provide a system, a method, a device, and the like, that enable the UE to timely report or indicate a successful LTM cell switch to the target cell and/or the target DU, even if the target cell is configured with Cell DTX/DRX. Accordingly, network resources may be conserved since unnecessary further LTM cell switch(es) can be avoided, and the ping-pong phenomenon described above may be efficiently avoided. If the ping pong is cannot be avoided, the network may issue an LTM cell switch command to move the UE to the correct cell even during the Cell DTX/DRX non-active duration. Ultimately, example embodiments of the present disclosure enable an efficient and effective LTM execution phase, even if the target cell involved in the LTM execution phase is configured with Cell DTX/DRX.

Furthermore, operations associated with the configuration of candidate/target cell(s) may take place at the CU, while the execution of the cell switch may take place autonomously at the DU without further interaction with the upper layers. Ultimately, example embodiments of the present disclosure provide system architecture and associated mechanisms for facilitating LTM interworking with Cell DTX/DRX at a target cell, in the disaggregated architecture.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations, as well as the technical advantages associated therewith, of example embodiments of the present disclosure are provided below.

### General System Architecture and General Operations

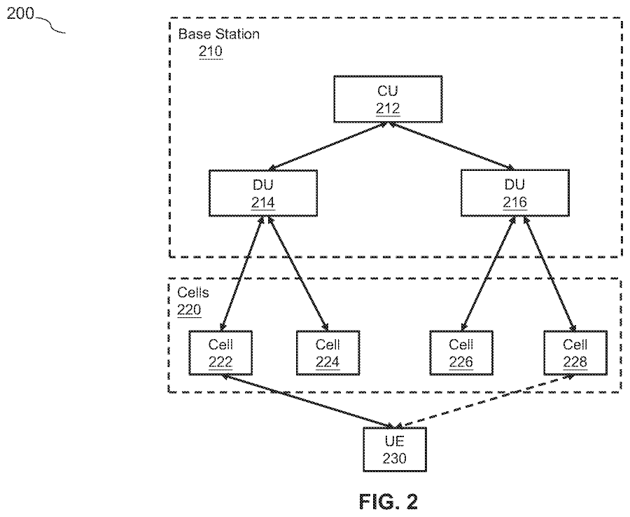

FIG. 2 illustrates a block diagram of a generic system architecture 200 in which one or more example embodiments may be implemented. As illustrated in FIG. 2, the system architecture 200 may include at least one base station 210, a plurality of cells 220, and at least one user equipment (UE) 230. It is contemplated that the components and configurations illustrated in FIG. 2 are merely examples of possible embodiments of the present disclosure, and the system architecture may include more/fewer components than as illustrated, and/or the components may be arranged in a manner different from as illustrated, without departing from the scope of the present disclosure.

The base station 210 may include at least one central unit (CU) 212 and a plurality of distributed units (DUs) 214-216. According to one or more embodiments, the base station may include a gNodeB (gNB) of 5G NR or a node in Next Generation Radio Access Network (NG-RAN). In this case, the CU 212 may be a gNB-CU, and the DUs 214-216 may be gNB-DUs. It is contemplated that the base station 210 may include any other suitable type of radio base station, such as an Evolved Node B (eNodeB) of a 4G LTE network, a base station of a 6G network, and the like, without departing from the scope of the present disclosure. Further, the communication between the CU 212 and the DUs 214-216 may be performed via an F1 interface.

According to one or more embodiments, the CU 212 and the DUs 214-216 may be defined in software form and may be deployed in one or more network nodes. For instance, the CU 212 and the DUs 214-216 may be deployed in one or more servers in the form of virtualized network function (VNF), containerized and/or cloud-native function (CNF), and the like.

According to one or more embodiments, the CU 212, the DU 214, and/or the DU 216 may be deployed in the same network node (e.g., same server) and/or may be located at a similar geographical location (e.g., be deployed in different servers in the same data center). According to one or more embodiments, the CU 212, the DU 214, and/or the DU 216 may be deployed in different network nodes and/or may be located at different geographical locations. For instance, the CU 212 may be deployed in one or more central servers (i.e., servers in one or more central data centers) further from the UE 230, and the DUs 214-216 may be deployed in one or more edge servers (i.e., servers in one or more edge data centers) nearer to the UE 230. Similarly, the DU 214 and DU 216 may be located at different geographical locations (e.g., be deployed in different servers, etc.).

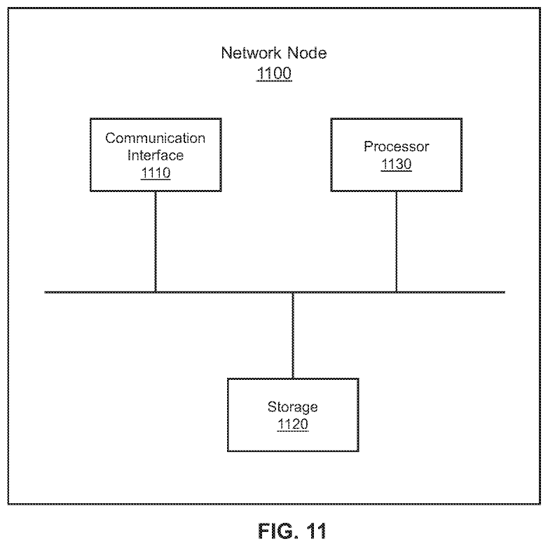

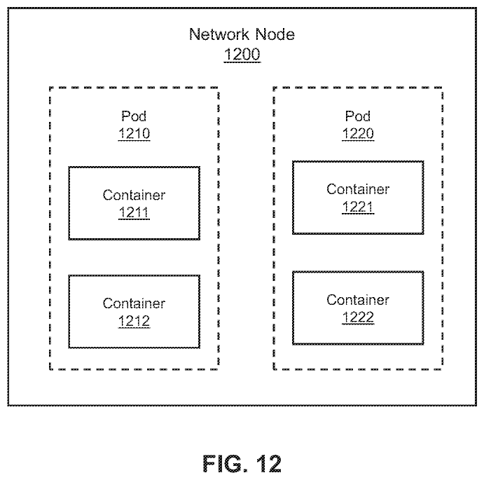

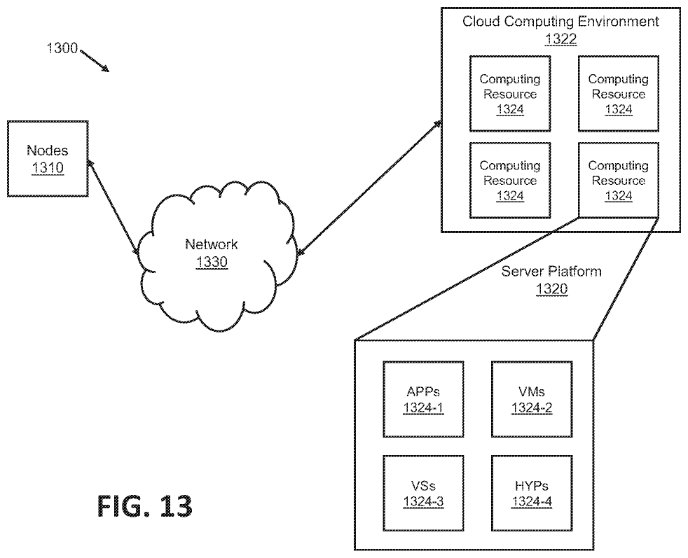

Descriptions of example network nodes, in which the CU 212 and/or the DUs 214-216 may be deployed, are provided below with reference to FIG. 11 to FIG. 12. Descriptions of an example environment, in which the CU 212 and/or the DUs 214-216 may be deployed, are provided below with reference to FIG. 13. In this regard, it is contemplated that one or more operations associated with the CU 212 and the DUs 214-216 described herein may be performed by one or more components of the associated network node, without departing from the scope of the present disclosure.

The DUs 214-216 may receive radio signals from an end user (via the UE 230 and the cells 220) and may provide operation or support for lower layers of protocol stacks (e.g., Radio Link Control (RLC) layer, Medium Access Control (MAC) layer, Physical Layer, etc.) accordingly. As an example, the DUs 214-216 may perform one or more scheduling operations. The CU 212 may communicatively couple the DUs 214-216 to a core network (e.g., 4G Evolved Packet Core (EPC) network, 5G Core network, etc.) and may receive the radio signals from the DUs, thereby providing operation or support for higher layers of protocol stacks (e.g., Packet Data Convergence Protocol (PDCP) layer, Radio Resource Control (RRC) layer, etc.) accordingly. As an example, the CU 212 may provide one or more configurations to the UE 230 via RRC signaling.

According to one or more embodiments, a single CU may host or serve multiple DUs. In the example of FIG. 2, the CU 212 may host or serve the DU 214 and the DU 216. It is contemplated that, in practice, a CU may host or serve less or more than two DUs, without departing from the scope of the present disclosure.

Referring still to FIG. 2, the cells 220 may include a plurality of cells 222-228. One or more of the cells 222-228 may include a macro cell, a micro cell, a pico cell, a femto cell, or any other suitable type of network cell. Each of the cells 222-228 may have an associated coverage area, in which at least one radio unit (RU), at least one antenna system, and any other suitable type of transport network element (TNE), may be deployed therein. According to one or more embodiments, one or more of the cells 222-228 may be configured with Cell DRX and/or Cell DTX.

Hereinbelow, a cell to which the UE 230 is connected may be referred to as a “serving cell”, a cell nearby the UE 230 and/or the serving cell may be referred to as a “neighboring cell”, a cell that may be selectable (from among one or more neighboring cells) for an LTM cell switch and for which the LTM configuration may be provided to the UE 230 may be referred to as a “candidate cell” or an “LTM candidate cell”, and a cell that is selected (from among one or more candidate cells) for undergoing the LTM cell switch may be referred to as a “target cell” or an “LTM target cell”. Similarly, a DU that serves or hosts the serving cell may be referred to as a “source DU” or a “serving DU”, a DU that serves or hosts the candidate cell may be referred to as a “candidate DU”, and a DU that serves or hosts the target cell may be referred to as a “target DU”.

For descriptive purposes, it may be assumed that in the example of FIG. 2, the cell 222 is a serving cell, the cells 224-228 are the neighboring cells, the cells 226-228 are the candidate cells, and the cell 228 is selected as the target cell. In this regard, since the cell 228 is selected from the candidate cells, the cell 228 may also be referred to as a candidate cell in some descriptions (e.g., descriptions associated with the cell 228 before it is selected as the target cell, etc.) and may be referred to as a target cell in some descriptions (e.g., descriptions associated with the cell 228 after it is selected as the target cell, etc.). Further, the DU 216 that serves or hosts the cell 228 may be referred to as a candidate DU and/or a target DU, due to a similar reason.

According to one or more embodiments, a single DU may host or serve multiple cells. For example, the DU may implement various radio technologies, such as Massive Multiple-Input Multiple-Output (MIMO), beamforming, and the like, to optimize radio communication among the multiple cells and the CU. In the example of FIG. 2, the DU 214 may host or serve the cells 222-224, and the DU 216 may host or serve the cells 226-228. Nevertheless, it is contemplated that, in practice, a DU may host or serve less or more than two cells, without departing from the scope of the present disclosure. Specifically, in some implementations, a single DU may concurrently host or serve hundreds (e.g., 512, etc.) of cells at a time.

Referring still to FIG. 2, the UE 230 may include one or more devices that may be utilized by one or more end users to access the telecommunication network. For instance, the UE 230 may include one or more of: a computing device (e.g., a desktop computer, a laptop computer, a tablet computer, a handheld computer, a smart speaker, a server, etc.), a mobile phone (e.g., a smartphone, a radiotelephone, etc.), a wearable device (e.g., a pair of smart glasses or a smart watch), a SIM-based device, and any other suitable device. According to one or more embodiments, the UE 230 may include a group of UEs, such as a plurality of devices, apparatuses, equipment, and the like, that are communicatively coupled to the same cell (e.g., serving cell 222).

According to one or more embodiments, the UE 230 may be configured with Connected mode DRX (C-DRX) for device energy saving. In this regard, it is contemplated that the example embodiments of the present disclosure are applicable to both situations in which the UE 230 is and is not configured with C-DRX.

Example operations and interactions among the base station 210 (e.g., the CU 212, DU 214, DU 216), the cells 220 (e.g., serving cell 222, neighboring cells 224-228), and the UE 230, are described in the following. The example operations for configuring one or more of the cells 222-228 with Cell DTX/DRX are described first, followed by the descriptions of the example operation for configuring the UE 230 with LTM, the example operations involved in the LTM preparation phase, and the example operations involved in the LTM execution phase.

During the bring-up process (e.g., initialization, activation, etc.), one or more of the cells 222-228 may obtain, from the associated DU, configuration of Cell DTX/DRX. The configuration associated with Cell DTX/DRX may be referred to as “Cell DTX/DRX configuration” herein. The Cell DTX/DRX configuration may include, for example, periodicity, start slot/offset, configurations of active duration/non-active duration, configuration of Cell DTX/DRX cycles, and the like. It is contemplated that the Cell DTX/DRX may also be characterized by one or more of the principles defined in one or more 3GPP specifications (e.g., specification provided by RAN WG2 (RAN2) of 3GPP Technical Specification Group Radio Access Network (TSG RAN), etc.).

Upon receiving the Cell DTX/DRX configuration, the cell(s) may apply the Cell DTX/DRX configuration to thereby be configured with the Cell DTX/DRX. For instance, the cell(s) may override the default on/off timer or power setting with the Cell DTX/DRX cycle, thereby enabling the cell to periodically enter sleep mode and wake-up mode according to the Cell DTX/DRX cycle.

According to one or more embodiments, the pattern or configuration for Cell DTX and Cell DRX may be different. For instance, the pattern of Cell DTX cycle and the pattern of Cell DRX cycle may be different. In this case, the cell may configure the Cell DTX cycle and the Cell DRX cycle separately. Conversely, the pattern or configuration for the Cell DTX and the Cell DRX may be common when both are configured. For example, the Cell DTX and the Cell DRX may have the same configuration on active duration, may have common cycle parameters, and the like. The Cell DTX and Cell DRX may be configured and activated separately. According to one or more embodiments, the cell may include a plurality of Cell DTX/DRX configurations or patterns. For instance, the cell may have two Cell DTX/DRX configurations or patterns, and the like. Further, different cells may have the same or different Cell DTX/DRX configurations or patterns. For instance, the serving cell 222 and the cell 224, which are both hosted or served by the DU 214, may have the same/different Cell DTX/DRX configurations or patterns.

Furthermore, the pattern or configuration of the Cell DTX/DRX cycles may be common for a plurality of UEs associated with a cell (e.g., a group of UEs connected to a serving cell, a ground of UEs attempting to switch to the same target cell, etc.). For instance, when the UE 230 includes a group of UEs that are connected to the same cell or attempting to switch to the same cell, said group of UEs may experience the same/common Cell DTX/DRX cycle of the cell.

For descriptive purposes, it may be assumed that at least the candidate/target cell 228 is configured with Cell DTX/DRX. According to one or more embodiments, the serving cell 222 and/or the neighboring cells 224-226 may also be configured with Cell DTX/DRX for network energy saving. In this regard, it is contemplated that the example embodiments of the present disclosure are applicable to both situations in which the serving cell 222 and/or the neighboring cells 224-226 are and are not configured with Cell DTX/DRX.

On the other hand, when the UE 230 is first connected to the serving cell 222, the base station 210 (e.g., CU 212) may provide, to the UE 230, configuration associated with LTM. The configuration associated with LTM may be referred to as “LTM configuration” herein. The LTM configuration may include, for example, an identity of a cell (e.g., a Cell ID of a candidate cell, a Cell ID of a target cell, etc.), the radio bearer of the cell, generic measurement configurations (e.g., a measurement gap, type of measurement such as intra-frequency measurement or inter-frequency measurement, etc.), reporting configuration, RRC configuration, and the like. The LTM configuration may be provide via RRC signaling (in one or more Radio Resource Control (RRC) messages, etc.). Accordingly, the UE 230 may be configured with the LTM based on the LTM configuration.

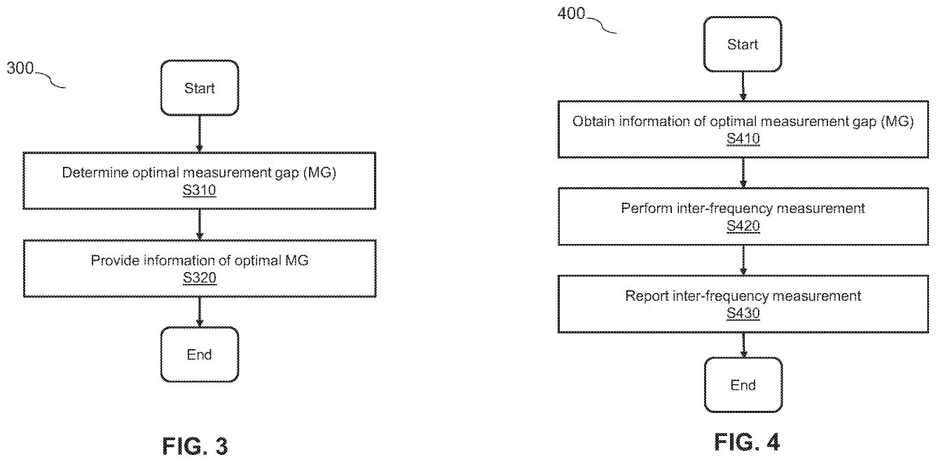

As further described below with reference to FIG. 3 to FIG. 7, according to one or more embodiments, the base station 210 may determine and provide an optimal measurement gap (MG) to the UE 230, in addition to or in alternative to the measurement gap included in the LTM configuration. The information of the optimal MG may be provided in the same/different messages (e.g., same/different RRC messages) that include the LTM configuration. According to one or more embodiments, the optimal MG may be included into the LTM configuration.

According to one or more embodiments, in addition to the LTM configuration, the base station 210 (e.g., CU 212) may further provide (to the UE 230) configurations which, when being utilized by the UE 230, enable the UE 230 to be configured with C-DRX. The configuration associated with C-DRX may be referred to as “C-DRX configuration” herein. The C-DRX configuration may include, for example, periodicity, start slot/offset, configuration of on-duration/off-duration, configuration of DRX cycles, and the like. The UE 230 may receive the C-DRX configuration in the same/different messages that include the LTM configuration.

To this end, the candidate/target cell 228 may be configured with Cell DTX/DRX and the UE 230 may be configured with LTM. The example operations during the LTM preparation phase are described in the following.

In operation, the UE 230 may connect to the serving cell 222 hosted or served by the serving DU 214, and may perform an LTM cell switch from the serving cell 222 to a target cell when required. According to one or more embodiments, the UE 230 may perform an intra-DU LTM cell switch, wherein the UE 230 may switch from a serving cell to a target cell that is served or hosted by the same serving DU (e.g., switch from serving cell 222 to cell 224). According to one or more embodiments, the UE 230 may perform an inter-DU LTM cell switch, wherein the UE 230 may switch from a serving cell to a target cell that is served or hosted by a different DU (e.g., switch from serving cell 222 to cell 228). The information of the type of cell switch and the target cell associated therewith are determined by the base station 210 during the LTM preparation phase.

Specifically, during the LTM preparation phase, the base station 210 (e.g., CU 212, DU 214, etc.) may select one or more LTM candidate cells from among a plurality of neighboring cells, and then prepare and provide the LTM configuration of the LTM candidate cells to the UE 230.

In this regard, the neighboring cells may operate in a frequency band that is the same/different from the frequency band of the serving cell 222. A cell that is operating within the same frequency band with the serving cell 222 may be referred to as an “intra-frequency cell”, and a cell that is operating on different frequency bands different from the serving cell 222 may be referred to as an “inter-frequency cell”. According to one or more embodiments, an intra-DU cell (i.e., a cell that is served or hosted by the serving DU) may be an intra-frequency cell, and an inter-DU cell (i.e., a cell that is served or hosted by a DU different from the serving DU) may be the inter-frequency cell. For descriptive purposes, it may be assumed that in the example of FIG. 2, the cell 224 (i.e., the intra-DU cell) is operating as an intra-frequency cell, and the cells 226 and 228 (i.e., the inter-DU cells) are operating as inter-frequency cells. It is contemplated that, in some implementations, an intra-DU cell may also be an inter-frequency cell, and an inter-DU cell may also be an intra-frequency cell, without departing from the scope of the present disclosure.

Further, in order to enable the base station 210 to select the LTM candidate cells from among the neighboring cells, the UE 230 needs to perform one or more measurements on the neighboring cells and then provide the measurement(s) to the base station 210, such that the base station may determine which of the neighboring cells are suitable to be selected as LTM candidate cell(s).

For instance, the UE 230 may perform one or more measurements on RSRP (and/or other suitable parameters) of the neighboring cells, and then provide or report the one or more RSRP (and/or other suitable parameters) measurements to the CU 212 via Layer 3 (L3). Thus, a measurement that is reported via L3 can also be referred to as an “L3 measurement”. The L3 measurement may include, for example, a Synchronization Signal Block (SSB)-based L3 measurement, a Channel State Information Reference (CSI-RS)-based L3 measurement, and the like. Since the L3 measurement may be sent to the CU 212 via RRC reporting (e.g., may be included in an RRC: Measurement Report, etc.), the L3 measurement may also be referred to as an “RRC measurement”. Similarly, during the LTM execution phase, the UE 230 may provide the one or more RSRP (and/or other suitable parameters) measurements to the serving DU 214 via Layer 1 (L1). In this regard, a measurement that is reported via L1 can also be referred to as an “L1 measurement”.

In view of the above, during the preparation phase, the UE 230 may perform one or more intra-frequency measurements (which are measurements on the neighboring intra-frequency cells) and/or one or more inter-frequency measurements (which are measurements on the neighboring inter-frequency cells), according to indication or instruction from the base station 210.

According to one or more embodiments, the base station 210 may first attempt to select one or more intra-frequency cells as the LTM candidate cell(s), and then attempt to select one or more inter-frequency cells as the LTM candidate cell(s) if there are no available or suitable intra-frequency cells. In this regard, in the procedures of preparing an inter-frequency cell as the LTM candidate cell, the base station 210 may provide information of inter-frequency measurement to the UE 230, such that the UE 230 may perform at least one inter-frequency measurement (e.g., an L3 measurement, etc.) on one or more neighboring inter-frequency cells based thereon. For instance, in order to enable the UE 230 to perform the inter-frequency measurement(s), the base station 210 may provide, to the UE 230 (via RRC signaling), information of a measurement gap (MG) of the associated inter-frequency cell(s) in the inter-frequency measurement information. As further described below with reference to FIG. 3 to FIG. 7, according to one or more embodiments, the base station 210 may determine and provide information of an optimal MG to enable the UE 230 to perform an inter-frequency measurement on an inter-frequency cell that is configured with Cell DTX/DRX.

Upon receiving the inter-frequency measurement information from the base station 210, the UE 230 may be configured to perform one or more inter-frequency measurements on one or more neighboring inter-frequency cells. Specifically, the UE 230 may utilize the optimal MG value to measure the associate inter-frequency cell (where Cell DTX/DRX is enabled or activated), and may utilize the regular MG value to measure the associate inter-frequency cell (where Cell DTX/DRX is disabled or deactivated).

Subsequently, the UE 230 may provide or report the inter-frequency measurement(s) to the base station 210, and the base station 210 may, based on the one or more inter-frequency measurements, select one or more of the measured inter-frequency cells as the LTM candidate cell(s) and then prepare the LTM configuration associated therewith. To this end, the preparation phase of the LTM cell switch may be completed, and the CU 212 may provide the LTM configuration of the LTM candidate cell(s) to the UE 230 thereby entering the LTM execution phase.

For descriptive purposes, it may be assumed that in the example of FIG. 2, the cell 224 is an intra-frequency cell and the cells 226-228 are inter-frequency cells, and both the cells 226-228 are selected as the LTM candidate cells during the LTM preparation phase.

During the LTM execution phase, the UE 230 may perform one or more L1 measurements on the LTM candidate cell(s) and provide/report the L1 measurement(s) to the serving cell 222 and/or the serving DU 214, thereby triggering the LTM cell switch when applicable. For instance, the UE 230 may continuously (or periodically) perform one or more L1 measurements on the serving cell 222 and/or one or more LTM candidate cells 226-228, and may send the results of the one or more L1 measurements (e.g., in the form of L1 measurement report(s), etc.) to the serving DU 214.

The serving DU 214 may determine, based on the one or more L1 measurements provided by the UE, a type of LTM cell switch the UE 230 should perform when the LTM cell switch is required. For instance, the serving DU 214 may determine whether the UE 230 should perform a RACH-based LTM cell switch or a RACH-less LTM cell switch when one or more LTM cell switch criteria are met. According to one or more embodiments, the serving DU 214 may prioritize the RACH-less LTM cell switch over the RACH-based LTM cell switch, since the RACH-less LTM cell switch may consume less time than the RACH-based LTM cell switch, and may reduce the risk of data interruption during handovers, thereby improving the user experience.

Assuming that the serving DU 214 has decided that the UE 230 should perform a RACH-less LTM cell switch when required, the serving DU 214 may request the UE 230 to perform one or more operations for uplink (UL) synchronization with the LTM candidate cell(s). Accordingly, the UE 230 may perform one or more operations (e.g., RACH procedures, etc.) to synchronize with the LTM candidate cell(s). Upon synchronizing with the LTM candidate cell(s), the DU(s) associated with the LTM candidate cell(s) (e.g., the candidate/target DU 216) may allocate or provide a dynamic scheduling grant to the UE 230, and/or may instruct or notify the LTM candidate cell(s) (e.g., cells 226-228) to allocate or provide a pre-configured grant to the UE 230. These grants allow the UE 230 to communicate with the DU 216 and send or provide a specific message or data packet to the target cell and/or the target DU at a later time, after the UE 230 has successfully performed the LTM cells switch.

Upon synchronizing with the LTM candidate cell(s), the UE 230 may continue to perform one or more L1 measurements on the LTM candidate cell(s) and provide/report the L1 measurement(s) to the serving cell 222 and/or the serving DU 214. The serving DU 214 may, based on the L1 measurement(s) determine whether or not an LTM cell switch is required.

Assuming that the serving DU 214 determines that the LTM cell switch is required, the serving DU 214 may select a target cell from among the LTM candidate cells. Accordingly, the serving DU 214 may generate a MAC CE containing a cell switch command, and then provide the MAC CE to the UE 230. The cell switch command may include an instruction to perform a serving cell change, a type of cell switch to be performed (e.g., RACH-less LTM cell switch, etc.), and information of the selected target cell (e.g., Cell ID, LTM configuration, etc.).

Upon receiving the cell switch command, the UE 230 may perform an LTM cell switch from the serving cell to the target cell indicated in the cell switch command. Assuming that the cell switch command instructs the UE 230 to perform a RACH-less LTM cell switch from the serving cell 222 to the target cell 228, the UE 230 may perform the RACH-less LTM cell switch as instructed. Accordingly, upon successfully performed the LTM cell switch, the UE 230 may send, to the target cell 228 and/or the target DU 216 (which are now the new serving cell and the new serving DU), at least one notification or message to indicate the successful LTM cell switch. If the Cell DTX/DRX is enabled/activated at the target cell 228, the UE 230 may utilize the allocated dynamic scheduling grant and/or the pre-configured grant to provide the associated/specific notification or message to the target cell 228 and/or the target DU 216.

To this end, the LTM execution phase is completed, and the target DU 214 is now acting as the new serving DU, and may initiate further LTM cell switch procedures (e.g., further LTM preparation phase and further LTM execution phase, etc.) if required.

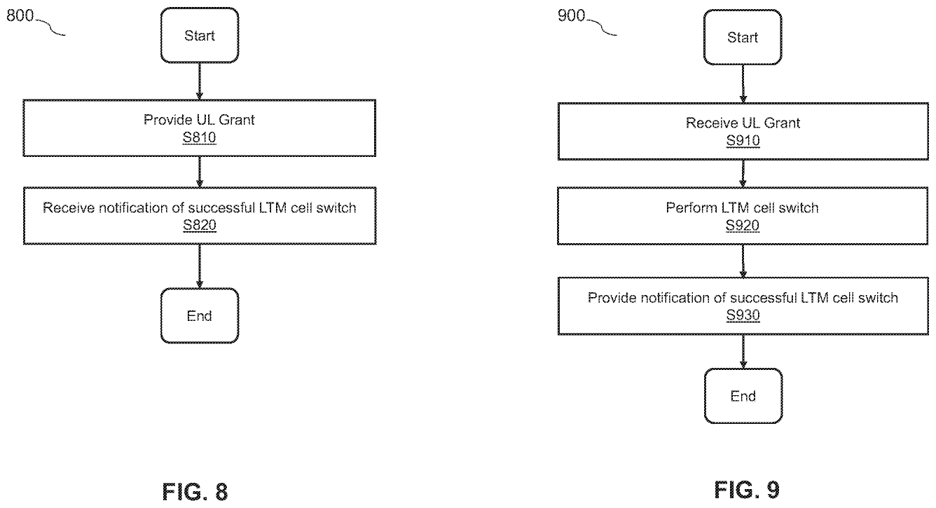

Further descriptions of the LTM preparation phase are provided below with reference to FIG. 3 to FIG. 7, and further descriptions of the LTM execution phase are provided below with reference to FIG. 8 to FIG. 10B

In view of the above, the UE 230 may perform a RACH-less LTM cell switch and then timely indicate or report the successful LTM cell switch to the target cell/target DU. Nevertheless, when being instructed to perform the LTM cell switch, if the UE has not yet obtained the TA of the target cell or if the acquired TA has expired, the UE may perform the RACH-based LTM cell switch by performing RACH procedures with the allocated RACH resources during the active duration of the Cell DTX/DRX cycle of the target cell. Accordingly, upon a successful RACH-based LTM cell switch, the UE can wait till the completion of a Cell DTX/DRX cycle to transmit the notification or indication of a successful LTM cell switch to the target cell and/or the target DU.

To this end, example embodiments of the present disclosure provide a system architecture, mechanism, procedure, and the like, for facilitating LTM interworking with Cell DTX/DRX at the target cell, thereby enabling proper execution of LTM cell switch to the target cell when the target cell is configured with Cell DTX/DRX.

Specifically, example embodiments of the present disclosure provide a system, a method, a device, and the like, that enable UE to efficiently and effectively perform inter-frequency measurement(s) on an inter-frequency cell(s) (i.e., a potential target cell), even if the inter-frequency cell(s) is configured with Cell DTX/DRX. Ultimately, example embodiments of the present disclosure enable an efficient and effective LTM preparation phase, even if the candidate/target cell(s) involved in the LTM preparation phase is configured with Cell DTX/DRX.

Further, example embodiments of the present disclosure provide a system, a method, a device, and the like, that enable the UE to timely report or indicate a successful LTM cell switch to the target cell and/or the target DU, even if the target cell is configured with Cell DTX/DRX. Accordingly, network resources may be conserved since unnecessary further LTM cell switch(es) can be avoided, and the ping-pong phenomenon described above may be efficiently avoided. Ultimately, example embodiments of the present disclosure enable an efficient and effective LTM execution phase, even if the target cell involved in the LTM execution phase is configured with Cell DTX/DRX.

Further, if a ping-pong back to the old serving cell cannot be avoided and the target cell is configured with Cell DTX/DRX, in case of a RACH-less LTM cell switch, the target DU may not be able to detect a successful LTM cell switch to the target cell as the UE may not send any uplink data during the non-active duration. Hence, the subsequent LTM cell switch to one of the old serving cell may be initiated by the new serving DU. Example embodiments of the present disclosure provide a system, a method, a device, and the like, that enable the UE to timely report or indicate a successful LTM cell switch to the target cell and/or the target DU, even if the target cell is configured with Cell DTX/DRX. Specifically, a UE can be configured to send a UL MAC CE to the target DU during the non-active duration, either by extending one of the active durations or introducing a new active duration during the Cell DTX/DRX cycle. This information can be provided to the UE in the LTM candidate/target cell configuration prepared by the candidate/target DU. Alternatively, the old serving DU may also inform the new serving DU about the LTM cell switch via the CU, over the F1 interface. This enables the new serving DU take action when a ping-pong to the old serving cell may be necessary.

Furthermore, operations associated with the configuration of candidate/target cell(s) may take place at the CU, while the execution of the cell switch may take place autonomously at the DU without further interaction with the upper layers. Ultimately, example embodiments of the present disclosure provide a system architecture and mechanisms for facilitating LTM interworking with Cell DTX/DRX at the target cell, in the disaggregated architecture.

### Example Operations During LTM Preparation Phase

As described above, during the LTM preparation phase of the LTM cell switch, the base station may decide to select one or more inter-frequency cells as the LTM candidate cell(s). In this case, the user equipment (UE) would be required to perform one or more inter-frequency measurements on the inter-frequency cell(s), and then report the inter-frequency measurement(s) to the base station, such that the base station may prepare the LTM candidate cell(s) from among the inter-frequency cell(s) based thereon.

In order to perform an inter-frequency measurement on an inter-frequency cell, the UE would be required to obtain information of a measurement gap (MG) of the inter-frequency cell. Specifically, the MG provides a dedicated duration or time window during which the UE may focus on measuring the signal strength and quality of the inter-frequency cell. For instance, the UE may, based on the MG of the inter-frequency cell, temporarily stop or pause one or more ongoing data transmissions/receptions to concentrate on assessing and performing measurements on the inter-frequency cell.

In the related art, the MG of a cell is generated by the base station, without considering whether or not the cell is configured with the Cell DTX/DRX. Accordingly, there is a possibility that the provided MG is not suitable or non-optimal for performing the inter-frequency measurement, if the inter-frequency cell is configured with Cell DTX/DRX. As a result, there may be delays in the UE performing and reporting the inter-frequency measurement(s), which consequently causes delays in the completion of the LTM preparation phase and delays in the LTM execution phase.

Example embodiments of the present disclosure provide a system, a device, a method, and the like, for determining and providing an optimal MG to the UE, such that the UE may utilize said optimal MG to effectively and efficiently perform an inter-frequency measurement on an inter-frequency cell. The operations associated therewith may include a distributed unit (DU), a central unit (CU), and a user equipment (UE). Example embodiments associated therewith are described hereinbelow with reference to FIG. 3 to FIG. 7.

Referring first to FIG. 3, which illustrates operations on the DU side. Specifically, FIG. 3 illustrates a flow diagram of an example method 300 for providing an optimal MG of an inter-frequency cell during an LTM preparation phase, according to one or more embodiments. One or more operations of method 300 may be performed by a DU or a component (e.g., a processor) of a network node in which the DU is deployed. The DU may be a candidate/target DU that serves or hosts an inter-frequency cell (which may then be selected as a candidate/target cell), such as the DU 216 in FIG. 2.

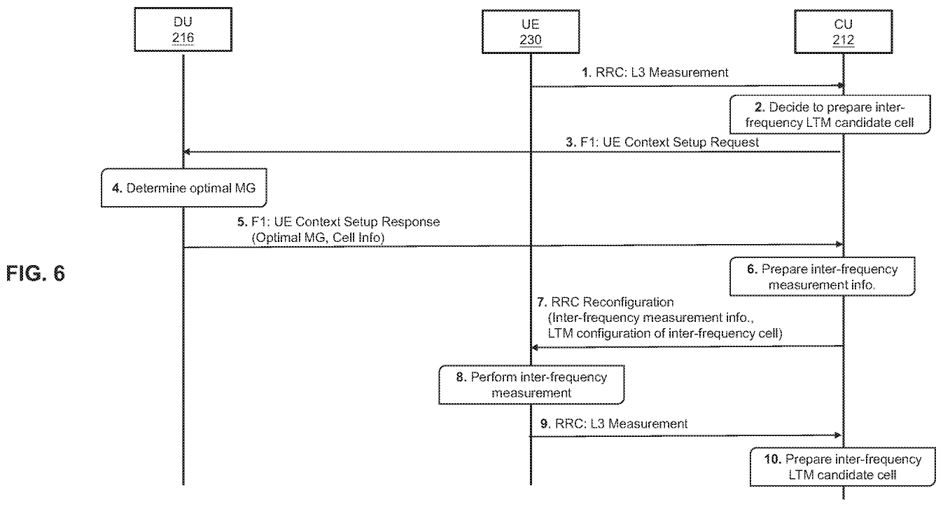

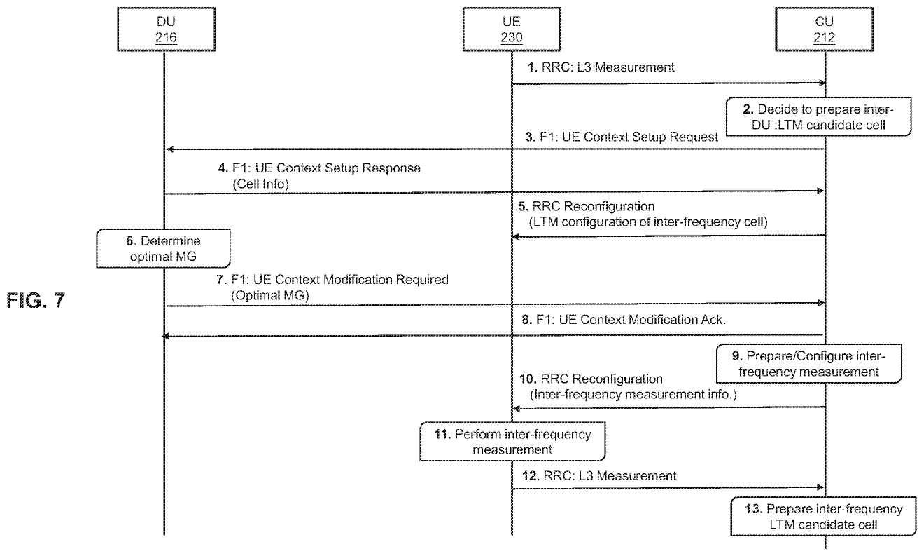

According to one or more embodiments, one or more operations of the method 300 may be triggered by a message or indication received by the DU from a CU. The CU may host or serve the DU and the serving DU associated with the serving cell. A brief description of the triggering of the method 300 is provided in the following, and further descriptions associated therewith are provided below with reference to example use cases in FIG. 6 and FIG. 7.

Specifically, the DU may receive, from the CU via the F1 interface, a request for configuration or information associated with one or more inter-frequency cells that are being served or hosted by the DU. In response, the DU may collect information and prepare configuration (e.g., MG, Cell ID, etc.) of the inter-frequency cell(s), and then provide the same to the CU.

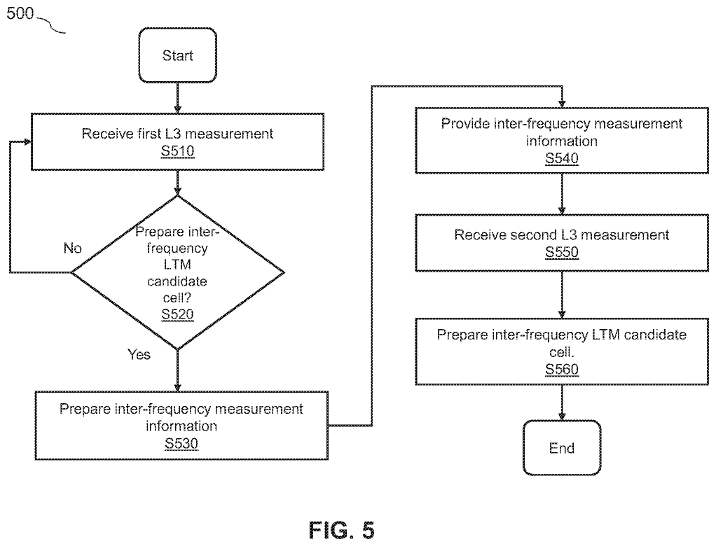

In this regard, if the inter-frequency cell(s) is not configured with Cell DTX/DRX, the DU may generate the MG for said inter-frequency cell(s) based on one or more measurement configurations that may be provided by the CU along with the request. For instance, as further described below with reference to FIG. 5, the CU may provide, to the DU, the request in a UE Context Setup Request message to prepare an LTM candidate cell for the UE, and the UE Context Setup Request message may further include one or more measurement timing configurations (e.g., SSB based measurement timing configuration (SMTC), etc.) that can be utilized by the DU in generating the MG for the inter-frequency cell(s). In this case, the MG generated based on the measurement timing information would be optimal since the inter-frequency cell(s) is not configured with Cell DTX/DRX and would not have the delays-related issues described above.

On the other hand, if the inter-frequency cell(s) is configured with the Cell DTX/DRX and has the Cell DTX/DRX disabled/deactivated (i.e., the cell(s) is in wake-up mode) when the DU receives the request from the CU, the DU may trigger the method 300 to thereby determining the information of the optimal MG and providing the same to the CU, in response to the request of the CU.

Alternatively, if the inter-frequency cell(s) is configured with the Cell DTX/DRX and has the Cell DTX/DRX enabled/deactivated (i.e., the cell(s) is in sleep mode) when the DU receives the request from the CU, the DU may trigger the method 300 in the next active duration of the associated Cell DTX/DRX cycle (i.e., when the cell(s) is in wake-up mode). In some implementations, the DU may first determine a regular MG and provide the same to the CU in response to the request of the CU, and then perform method 300 to determine and provide an optimal MG (when the cell(s) enters wake-up mode in the next active duration) to the CU thereafter.

Descriptions of operations in the method 300 are provided in the following. Referring to FIG. 3, at operation S310, the DU may be configured to determine an optimal measurement gap (MG). According to one or more embodiments, the DU may determine the optimal MG based on an active duration of a Cell DTX/DRX cycle(s) of an inter-frequency cell(s).

According to one or more embodiments, the DU may determine, based on the Cell DTX/DRX configuration of the inter-frequency cell(s), one or more parameters that define the optimal MG. The one or more parameters may include, for example, a measurement gap repetition period (MGRP) that defines the periods of the MG (in ms, etc.), a gap offset that defines the starting subframe when the MG starts, a measurement gap length (MGL) that specifies the duration of the MG (in ms, etc.), a measurement gap timing advance (MGTA) that specifies when the UE can start measurements in advance of the subframe when the MG starts.

According to one or more embodiments, the DU may select one or more of the aforesaid parameters, according to the Cell DTX/DRX configuration of the inter-frequency cell(s). For instance, based on determining that the active duration of the Cell DTX/DRX cycle is “x ms”, the DU may select, from a plurality of predefined MGLs (e.g., 1.5 ms, 3 ms, 3.5 ms, 4 ms, 5.5 ms, 6 ms, etc.), an MGL that has a value greater than or equal to “x ms”. As another example, the DU may select, from a plurality of predefined MGRPs (e.g., 20 ms, 40 ms, 80 ms, 160 ms, etc.), an MGRP that is consistent with the Cell DTX/DRX cycle. Alternatively or additionally, the DU may modify one or more of the predefined parameters. For instance, the DU may first select a predefined MGL and then add an additional duration thereto.

To this end, the DU may determine or generate an optimal MG that is greater than or equal to the time required for the UE to perform an inter-frequency measurement(s) on the inter-frequency cell(s), when the inter-frequency cell(s) is configured with the Cell DTX/DRX. Upon determining the optimal MG, the method 300 may proceed to operation S320, at which the DU may be configured to provide the information of the optimal MG to the UE, such that the information of the optimal MG can be utilized by the UE to perform an inter-frequency measurement.

According to one or more embodiments, the DU may provide the information of the optimal MG to the CU, and the CU may route or provide the said information to the UE. In some implementations, the DU may provide the information of the optimal MG to the CU, in response to a request or a message from the CU.

As described above, the DU may receive, from the CU via the F1 interface, the UE Context Setup Request message that triggers the method 300. In that case, if the Cell DTX/DRX feature is enabled in the candidate cell, (i.e., the inter-frequency cell(s), the DU may response to the CU with a UE Context Setup Response message that includes the information of the optimal MG. For instance, the information of the optimal MG may be included in one or more information elements (IEs) (e.g., MeasGapConfig IE, DU to CU RRC Information IE, etc.).

On the other hand, if the Cell DTX/DRX feature is yet to be activated in the candidate cell (i.e., the inter-frequency cell(s)) when the DU receives the UE Context Setup Request message and the operation S310 is performed after a period of time, the DU may provide the information of the optimal MG by initiating a UE context modification procedure. For instance, the DU may provide, to the CU via the F1 interface, a UE Context Modification Required message to initiate the UE context modification procedure, and may provide the information of the optimal MG by including said information into the UE Context Modification Required message. For instance, the DU may include the information of the optimal MG in one or more IEs (e.g., CellGroupConfig IE, DU to CU RRC Information IE, etc.) contained in the UE Context Modification Required message.

Upon receiving the information of the optimal MG from the DU, the CU may prepare inter-frequency measurement information that includes the optimal MG, and then provide said information to the UE. Accordingly, the UE may utilize the information of the optimal MG to perform inter-frequency measurement(s) when required. For instance, as further described below with reference to FIG. 4 and FIG. 5, the CU may provide the information of the optimal MG to the UE via at least one RRC Reconfiguration message. According to one or more embodiments, the CU may include the information of the optimal MG in the LTM configuration of the candidate cell(s), and may provide the same to the UE when providing the LTM configuration of the candidate cell(s) to the UE.

Referring next to FIG. 4, which illustrates operations on the UE side. Specifically, FIG. 4 illustrates a flow diagram of an example method 400 for performing an inter-frequency measurement during an LTM preparation phase, according to one or more embodiments. One or more operations of method 400 may be performed by a user equipment (UE), such as the UE 230 in FIG. 2. The UE may be configured with LTM, and may be communicatively coupled to a serving cell associated with a serving DU and a CU.

As illustrated in FIG. 4, at operation S410, the UE may be configured to obtain information of at least one optimal measurement gap (MG) associated with at least one inter-frequency cell. Specifically, the UE may receive the information of the optimal MG from a DU associated with the inter-frequency cell(s), via a CU. The CU may serve or host the serving DU and the DU that is associated with the inter-frequency cell(s).

According to one or more embodiments, the UE may receive an RRC Reconfiguration message from the CU. The RRC Reconfiguration message may include information of inter-frequency measurement (may be referred to as “inter-frequency information”), such as a value of a regular MG associated with an inter-frequency cell(s) that is not configured with Cell DTX/DRX or has the Cell DTX/DRX disabled/deactivated, a value of optimal MG associated with an inter-frequency cell(s) that has the Cell DTX/DRX enabled/activated, Cell ID of inter-frequency cell(s) on which the UE should perform the inter-frequency measurement, and the like. Further, the RRC Reconfiguration message may also include the LTM configuration of the inter-frequency cell(s). In some implementation, the UE may receive the inter-frequency measurement information and the LTM configuration of the inter-frequency cell(s) in the same RRC Reconfiguration message (an example embodiment associated therewith are described below with reference to FIG. 6). Alternatively, the UE may receive the inter-frequency measurement information and the LTM configuration of the inter-frequency cell(s) in different RRC Reconfiguration messages (an example embodiment associated therewith are described below with reference to FIG. 7).

Referring still to FIG. 4, upon obtaining the information of the optimal MG, the method 400 may proceed to operation S420, at which the UE may be configured to perform, based on the optimal MG and the inter-frequency measurement information, an inter-frequency measurement(s) on an inter-frequency cell(s). Specifically, the UE may determine, based on the inter-frequency measurement information, which of the cells should be measured, when the cell(s) should be measured, and the like. Subsequently, the UE may, based on the information of the MG and/or optimal MG, temporarily suspend or stop one or more ongoing data transmissions/receptions to perform the inter-frequency measurement(s) on the inter-frequency cell(s). During the MG/optimal MG, the UE may focus on assessing and measuring the inter-frequency cell(s) without interruption or interference from its own ongoing data transmission/reception.

According to one or more embodiments in which the inter-frequency cell has enabled/activated the Cell DTX/DRX, the UE may be configured to perform the inter-frequency measurement(s) according to the Cell DTX/DRX cycle of the inter-frequency cell. For instance, the UE may perform the inter-frequency measurement(s) by determining whether or not an active duration of the Cell DTX/DRX cycle associated with the inter-frequency cell is shorter than the associated optimal MG. Accordingly, based on determining that the active duration is shorter than the optimal MG, the UE may perform the inter-frequency measurement(s) over multiple active durations, according to the associated optimal MG. Conversely, based on determining that the active duration is equal to or longer than the optimal MG, the UE may perform the inter-frequency measurement(s) over one active duration, according to the associated optimal MG.

Upon performing the one or more inter-frequency measurements, the method 400 may proceed to operation S430, at which the UE may be configured to report, to the CU, the one or more inter-frequency measurements. According to one or more embodiments, the one or more inter-frequency measurements may include one or more L3 measurements, and the UE may report the one or more inter-frequency measurements via RRC reporting. For instance, the one or more L3 measurements may include one or more RRC measurements, and the UE may report the one or more L3 measurements to the CU via the RRC layer or the RRC interface.

Upon receiving the inter-frequency measurement report(s) from the UE, the CU may prepare one or more inter-frequency LTM candidate cells from among a plurality of neighboring inter-frequency cell(s).

Referring next to FIG. 5, which illustrates operations on the CU side. Specifically, FIG. 5 illustrates a flow diagram of an example method 500 for preparing at least one inter-frequency LTM candidate cell during an LTM preparation phase, according to one or more embodiments. One or more operations of method 500 may be performed by a central unit (CU), such as the CU 212 in FIG. 2. The CU may host or serve a serving DU and a candidate/target DU, and may be communicatively coupled to a UE via the serving DU and the serving cell associated therewith.

As illustrated in FIG. 5, at operation S510, the CU may be configured to receive a first L3 measurement from the UE. Specifically, the CU may receive, from the UE via the RRC layer or RRC interface, at least one L3 measurement associated with at least one neighboring intra-frequency cell. The L3 measurement(s) may include one or more parameters defining the signal strength and quality of the neighboring intra-frequency cell(s), such as Reference Signal Received Power (RSRP), Reference Signal Received Quality (RSRQ), Signal-to-Noise and Interference Ratio (SINR), and the like.

Upon receiving the first L3 measurement(s), the method 500 may proceed to operation S520, at which the CU may be configured to decide or determine whether or not an inter-frequency LTM candidate cell should be prepared. Specifically, the CU may determine, based on the first L3 measurement(s), whether or not any of the neighboring intra-frequency cell(s) can be selected as the LTM candidate cell (may be referred to as “intra-frequency LTM candidate cell”). For instance, the CU may determine whether or not any of the neighboring intra-frequency cell(s) can offer a better signal quality than the serving cell, and then select the neighboring intra-frequency cell(s) as the LTM candidate cell (if any).

Accordingly, based on determining that one or more of the neighboring intra-frequency cell(s) can be selected as the LTM candidate cell, the CU may decide that it is not required to prepare the inter-frequency LTM candidate cell. In this case, the method 500 may return to operation S510, such that the CU may repeatedly (e.g., continuously, periodically, etc.) perform operations S510 and S520 for at least a period of time.

On the other hand, based on determining that none of the neighboring intra-frequency cell(s) can be selected as the LTM candidate cell, the CU may decide that the inter-frequency LTM candidate cell(s) should be prepared. In this case, the method 500 may proceed to operation S530, at which the CU may be configured to prepare inter-frequency measurement information that enables the UE to perform at least one inter-frequency measurement on at least one inter-frequency cell.

According to one or more embodiments, the CU may obtain the information of the optimal MG by providing, to the DU associated with the inter-frequency cell(s) via the F1 interface, a UE Context Setup Request message. The UE Context Setup Request message may include a request for information of a cell(s) that is being hosted or served by the DU, such as a request for measuring gap(s) of the cell(s). Further, the UE Context Setup Request message may also include one or more measurement timing configurations (e.g., SMTC, etc.) that can be utilized by the DU to prepare or generate the MG and/or the optimal MG for the cell(s).

Accordingly, the DU may utilize the information included in the UE Context Setup Request message to determine an MG for a cell(s) that is not configured with Cell DTX/DRX, and/or to determine an optimal MG for a cell(s) that is configured with Cell DTX/DRX, as described above with reference to operation S310 in FIG. 3. Further, as described above with reference to operation S320 of the method 300, in some embodiments, the DU may provide, to the CU via the F1 interface, a UE Context Setup Response message or a UE Context Modification Required message that includes the information of the optimal MG. In this case, during operation S530, the CU may be configured to receive the UE Context Setup Response message/UE Context Modification Required message, and then obtain the information of the optimal MG therefrom.

In this regard, the CU may obtain the requested information (e.g., information of MG/optimal MG of the cell(s), etc.) from the DU, and then prepare the inter-frequency measurement information based thereon. According to one or more embodiments, the inter-frequency measurement information may further include information associated with a measurement object (e.g., frequency information of the measurement object, etc.), information associated with reporting configuration (e.g., reporting criterion, reporting format, etc.), information associated with measurement identities (e.g., a list of identities each of which is associated with a measurement object and the respective reporting configuration, etc.), information of measurement gaps (e.g., MGRP of the optimal MG, MGL of the optimal MG, MGTA of the optimal MG, gap offset of the optimal MG, etc.), and any other suitable information.

According to one or more embodiments in which the DU has provided information of multiple cells, the CU may compile the information of multiple cells in the inter-frequency measurement information. For instance, assuming that the DU has provided information of a cell that is not configured with Cell DTX/DRX and information of a cell that is configured with Cell DTX/DRX, the CU may include the information of both cells in the inter-frequency measurement information. Alternatively or additionally, the inter-frequency measurement information may include information of a cell under different modes. For instance, for a cell that is configured with Cell DTX/DRX, the inter-frequency measurement information may include a value of a regular MG that is generated by the DU (based on SMTC information provided by the CU, etc.) when the cell has disabled/deactivated the Cell DTX/DRX, and may also include a value of an optimal MG that is generated by the DU (based on Cell DTX/DRX configuration of the cell) when the cell has enabled/activated the Cell DTX/DRX.

Referring still to FIG. 5, upon preparing the inter-frequency measurement information, the method 500 may proceed to operation S540, at which the CU may be configured to provide the inter-frequency measurement information to the UE. According to one or more embodiments, the CU may generate an RRC Reconfiguration message that includes the inter-frequency measurement information (that may also include the information of the optimal MG). According to one or more embodiments, the RRC Reconfiguration message may further include the LTM configuration of the inter-frequency cells (may be referred to as “inter-frequency candidate cell LTM configuration” herein). According to one or more embodiments, the inter-frequency candidate cell LTM configuration may include the information of the optimal MG and/or the inter-frequency measurement information. Alternatively, the inter-frequency cell LTM configuration may be provided to the UE in a RRC Reconfiguration message different from the one that includes the inter-frequency measurement information.

Subsequently, the method 500 may proceed to operation S550, at which the CU may be configured to receive a second L3 measurement from the UE. Similar to the first L3 measurement (received at operation S510), the second L3 measurement may be received by the CU from the UE via the RRC layer or RRC interface. The second L3 measurement may be different from the first L3 measurement in that, the first L3 measurement is associated with the intra-frequency cell(s), while the second L3 measurement is associated with inter-frequency cell(s). Specifically, the second L3 measurement may include one or more parameters defining the signal strength and quality of the inter-frequency cell(s), such as RSRP, RSRQ, SINR, and the like. The second L3 measurement may be inter-frequency measurement performed by the UE based on the inter-frequency measurement information provided by the CU (at step S540).

Upon receiving the second L3 measurement(s), the method 500 may proceed to operation S560, at which the CU may be configured to prepare at least one inter-frequency LTM candidate cell from among the inter-frequency cell(s). Specifically, the CU may select, based on the second L3 measurement, one or more of the inter-frequency cell(s) that has met at least one condition as the inter-frequency LTM candidate cell(s). For example, the CU may determine which of the inter-frequency cell(s) can provide better signal strength and quality (as compared to the serving cell), and then select the inter-frequency cell(s) that can provide better signal strength and quality as the inter-frequency LTM candidate cell(s).

In some implementations, the operations of the method 300, the method 400, and the method 500 may be performed in any possible sequence. Example embodiments associated therewith are described in the following with reference to FIG. 6 and FIG. 7.

FIG. 6 illustrates a flow sequence of a first example use case of an LTM preparation phase that involves the operations in the methods 300 to 500, according to one or more embodiments. The flow sequence may involve at least one DU, at least one UE, and at least one CU. The at least one UE may be configured with LTM, and one or more cells being served or hosted by the at least one DU may be configured with Cell DTX/DRX.

For descriptive purposes, the example embodiment of FIG. 6 is illustrated as involving the candidate/target DU 216, the UE 230, and the CU 212 described above with reference to FIG. 2. Further, for descriptive purposes, some operations in FIG. 6 may also be described with reference to FIG. 2, along with one or more non-exhaustive assumptions or example conditions.

Referring to FIG. 6, at step 1, the UE 230 may provide, to the CU 212 via RRC signaling or RRC interface, a first L3 measurement report. The CU 212 may receive, from the UE 230 via the RRC signaling or RRC interface, the first L3 measurement report (similar to operation S510 in the method 500). The first L3 measurement report may include one or more parameters (e.g., RSRP, SINR, etc.) defining the signal strength and quality of one or more intra-frequency cells.

As a non-limiting example, referring to FIG. 2, it may be assumed that the cell 224 is operating within the same frequency as the serving cell 222, and thus is an intra-frequency cell for the UE 230. In this regard, at step 1 of FIG. 6, the UE 230 may perform one or more intra-frequency measurements on the cell 224, and then provide the measurement(s) in the form of L3 measurement report(s) to the CU 212.

Referring back to FIG. 6, at step 2, the CU 212 may decide, based on the first L3 measurement(s), whether or not at least one inter-frequency LTM candidate cell should be prepared (similar to operation S520 in the method 500). For instance, the CU 212 may determine, based on the first L3 measurement(s), whether or not the available intra-frequency cell (e.g., cell 224) may be selected as an LTM candidate cell. Accordingly, based on determining that the intra-frequency cell may not be selected as the LTM candidate cell, the CU 212 may decide to prepare at least one inter-frequency LTM candidate cell. In some implementations, the CU 212 may determine that at least one inter-frequency LTM candidate cell should be prepared, even if the available intra-frequency cell may be selected as the LTM candidate cell. For descriptive purposes, it may be assumed that in the example of FIG. 6, the CU 212 has decided to prepare at least one inter-frequency LTM candidate cell.

Accordingly, at step 3, the CU 212 may provide, to the DU 216 via the F1 interface, a UE Context Setup Request message for requesting the information of the inter-frequency cell(s) that is being served or hosted by the DU 216, in order to prepare at least one LTM candidate cell for the UE 230.

As a non-limiting example, referring to FIG. 2, it may be considered that the cells 226 and 228 (which are inter-DU cells) are operating at different frequencies from the serving cell 222, and thus the cells 226 and 228 are the inter-frequency cells of the UE 230. In this regard, at step 3 of FIG. 6, The CU 212 may send the UE Context Setup Request message, which includes a request for the information of the cells 226 and 228, to the DU 216 via the F1 interface.

At step 4, the DU 216 may determine at least one optimal MG for at least one inter-frequency cell that is configured with Cell DTX/DRX (similar to operation S310 in the method 300). In some implementations, the DU 216 may further determine, based on the information included in the UE Context Setup Request message (e.g., SMTC information, etc.), a normal/regular MG for said inter-frequency cell(s), such that the UE may utilize said normal MG when said inter-frequency cell(s) has deactivated/disabled the Cell DTX/DRX.

As a non-limiting example, referring to FIG. 2, it may be assumed that both of the cells 226-228 are configured with Cell DTX/DRX. In this case, the DU 216 may determine an optimal MG for each of the cells 226-228. Further, the DU 216 may also determine a normal/regular MG for each of the cells 226-228.

Subsequently, at step 5, the DU 214 may provide, to the CU 212 via the F1 interface, a UE Context Setup Response message. The UE Context Setup Response message may include information of the optimal MG and the information associated with the at least one inter-frequency cell (e.g., Cell ID, Cell DTX/DRX configuration, etc.).

Upon receiving the UE Context Setup Response message, at step 6, the CU 212 may prepare inter-frequency measurement information based thereon (similar to operation S530 in the method 500). For descriptive purposes, it may be assumed that the inter-frequency measurement prepared by the CU 212 includes information of an optimal MG and a normal/regular MG of two inter-frequency cells (e.g., cells 226-228 in FIG. 2).

Next, at step 7, the CU 212 may provide the inter-frequency measurement information to the UE 230 (similar to operation S540 in the method 500). Specifically, the CU 212 may generate an RRC Reconfiguration message that includes the inter-frequency measurement information (that also includes the information of the optimal MG and normal/regular MG) and provide the same to the UE 230. For descriptive purposes, it may be assumed that in the example of FIG. 6, the RRC Reconfiguration message further includes the LTM configuration of the inter-frequency cell(s). In some embodiments, the LTM configuration of the inter-frequency cell(s) may include the inter-frequency measurement information and the information of the optimal MG and normal/regular MG.

Upon receiving the RRC Reconfiguration message, at step 8, the UE 230 may perform one or more inter-frequency measurements on the inter-frequency cell(s), based on the inter-frequency measurement information (similar to operation S420 in the method 400).

For descriptive purposes, it may be assumed that in the example of FIG. 6, the UE 230 is performing inter-frequency measurement(s) on two inter-frequency cells (e.g., cells 226-228), wherein one of the inter-frequency cells (e.g., cell 226) has the Cell DTX/DRX disabled/deactivated, and another one of the inter-frequency cells (e.g., cell 228) has the Cell DTX/DRX enabled/activated. In this case, the UE 230 may perform (based on the normal/regular MG) at least one inter-frequency measurement on the inter-frequency cell that has the Cell DTX/DRX disabled/deactivated, and may perform (based on the optimal MG) at least one inter-frequency measurement on the inter-frequency cell that has the Cell DTX/DRX enabled/activated.

Subsequently, at step 9, the UE 230 may provide, to the CU 212 via RRC signaling or RRC interface, a second L3 measurement report. The CU 212 may receive, from the UE 230 via the RRC signaling or RRC interface, the second L3 measurement report (similar to operation S550 in the method 500). The second L3 measurement report may include one or more parameters (e.g., RSRP, SINR, etc.) defining the signal strength and quality of the inter-frequency cell(s) measured at step 8.

Accordingly, at step 10, the CU 212 may prepare, based on the second L3 measurement report, at least one inter-frequency LTM candidate cell from among the available inter-frequency cell(s) (similar to operation S560 in FIG. 5). For instance, the CU 212 may determine which of the inter-frequency cells (e.g., cells 226-228) has met at least one criteria/condition, and then select the inter-frequency cell(s) that has met the criteria/condition(s) as the LTM candidate cell(s). For descriptive purposes, it may be assumed that the CU 212 has selected two inter-frequency cells (e.g., cells 226-228) as the inter-frequency LTM candidate cells.

Subsequently, the first example use case of LTM preparation phase may be completed and the CU 212 may prepare and provide the LTM configuration of the inter-frequency LTM candidate cell(s) to the UE 230 for LTM execution (example embodiments associated therewith are provided below with reference to FIG. 8 to FIG. 10B).

FIG. 7 illustrates a flow sequence of a second example use case of an LTM preparation phase that involves the operations in the methods 300 to 500, according to one or more embodiments. Similar to the flow sequence in FIG. 6, the flow sequence in FIG. 7 may also involve at least one DU (e.g., DU 216), at least one UE (e.g., UE 230), and at least one CU (e.g., CU 212). The at least one UE may be configured with LTM, and one or more cells being served or hosted by the at least one DU may be configured with Cell DTX/DRX. Similarly, for descriptive purposes, some operations in FIG. 6 may also be described with reference to FIG. 2, along with one or more non-exhaustive assumptions or example conditions.

Further, the flow sequence in FIG. 7 may include one or more operations described above with reference to the flow sequence in FIG. 6. For instance, steps 1, 2, 3, 9, 11, 12, and 13 in FIG. 7 may be similar to steps 1, 2, 3, 8, 9, and 10 in FIG. 6, respectively. Thus, redundant descriptions associated therewith may be omitted below for conciseness.

The example use case in FIG. 7 is different from the example use case in FIG. 6 in that, upon receiving the UE Context Setup Request message from the CU 2121 (at step 3), instead of triggering the method for determining and provisioning of optimal MG (e.g., method 300), the DU 216 may first reply the CU 212 (via the F1 interface) with the UE Context Setup Response without including the information of the optimal MG of the inter-frequency cell(s) therein.

For instance, assuming that the inter-frequency cell(s) is not yet configured with Cell DTX/DRX when the DU 216 receives the UE Context Setup Request message, the DU 216 may simply determine, based on the information included in the UE Context Setup Request message (e.g., SMTC information, etc.), a normal/regular MG for said inter-frequency cell(s), without determining the optimal MG for said inter-frequency cell(s). In this case, at step 4, the DU 216 may simply include the information of the inter-frequency cell(s), such as Cell ID and the information of the normal/regular MG, into the UE Context Setup Response, and then provide the same to the CU 212 (via the F1 interface). Subsequently, at step 5, the CU 212 may prepare and provide a first RRC Reconfiguration message (that includes LTM configuration of the inter-frequency cell(s), without information of optimal MG) to the UE 230.

Later, when the inter-frequency cell(s) is configured with the Cell DTX/DRX (after the UE 230 received the associated LTM configuration), at step 6, the DU 216 may determine the optimal MG for the inter-frequency cell(s) based on the associated Cell DTX/DRX configuration (similar to operation S310 in the method 300). Subsequently, at step 7, the DU 216 may prepare and send a UE Context Modification Required message that includes the information of the optimal MG, thereby notifying the CU 212 that said inter-frequency cell(s) is now configured with Cell DTX/DRX and informing the CU 212 to update the information associated with said inter-frequency cell(s). Upon receiving the UE Context Modification Required message from the DU 216, at step 8, the CU 212 may provide, to the DU 216 via the F1 interface, a UE Context Modification Acknowledge message to acknowledge the receipt of the UE Context Modification Required message.

Accordingly, at step 9, the CU 212 may prepare new inter-frequency measurement information or configure existing inter-frequency measurement information to include the updated information (e.g., information of the newly received optimal MG, etc.) therein. Then, at step 10, the CU 212 may generate a second RRC Reconfiguration message to provide the new/updated inter-frequency measurement information to the UE 230. Accordingly, the UE 230 may utilize the inter-frequency measurement information to perform one or more inter-frequency measurements (at step 11) and may provide a second L3 measurement to the CU 212 (at step 12), and the CU 212 may prepare one or more inter-frequency LTM candidate cells based thereon (at step 13).

It is contemplated that the example operations and use cases described above with reference to FIG. 3 to FIG. 7 are merely examples, and should not limit the scope of the present disclosure by any means. Specifically, one or more operations described above may include more/fewer steps, may be performed in a different sequence, and the like, without departing from the scope of the present disclosure.

In view of the above, example embodiments of the present disclosure provide systems, methods, devices, and the like, that effectively and efficiently facilitate LTM interworking with Cell DTX/DRX at a cell (that may be selected as a target cell) during the LTM preparation phase.

Specifically, example embodiments determine and provide an optimal MG to the UE in various ways, thereby enabling the UE to utilize the optimal MG to effectively and efficiently perform one or more measurements on the cell(s) that is configured with Cell DTX/DRX during the LTM preparation phase, without delaying the measurement(s) and the associated reporting process. Ultimately, example embodiments of the present disclosure enable an efficient and effective LTM preparation phase, even if the cell(s) involved in the LTM preparation phase is configured with Cell DTX/DRX.

### Example Operations During LTM Execution Phase

As described above, during the LTM execution phase of the LTM cell switch, the base station may decide whether a RACH-based LTM cell switch or a RACH-less LTM cell switch should be performed when required. According to one or more embodiments, when the base station decides that a RACH-less LTM cell switch should be performed when required, the base station may allocate or provide one or more uplink (UL) grants to the UE, such that the UE may timely report or indicate a successful LTM cell switch to the target cell and/or the target DU (which are acting as the new serving cell and the new source DU upon the successful LTM cell switch).

In the following, descriptions of example operations involved in the LTM execution phase are provided with reference to FIG. 8 to FIG. 10B. It is noted that, although some descriptions provided herein below may make reference to one or more of FIG. 3 to FIG. 7, said descriptions do not necessarily restrict the embodiments of FIG. 8 to FIG. 10B with the features and operations of FIG. 3 to FIG. 7. For instance, although the operations of FIG. 8 to FIG. 10B may be involved in an LTM execution phase subsequent to the LTM preparation phase that involves the operations in FIG. 3 to FIG. 7 (e.g., operations that associate with inter-frequency LTM candidate cells), it is contemplated that the operations of FIG. 8 to FIG. 10B may also be involved in an LTM execution phase subsequent to an LTM preparation phase that involves operations for selecting and preparing intra-frequency LTM candidate cells, without departing from the scope of the present disclosure.

Referring first to FIG. 8, which illustrates operations on the DU side. Specifically, FIG. 8 illustrates a flow diagram of an example method 800 for utilizing at least one UL grant to receive at least one notification of a successful LTM cell switch during an LTM execution phase, according to one or more embodiments. One or more operations of method 800 may be performed by a DU or a component (e.g., a processor) of a network node in which the DU is deployed. The DU may be a candidate/target DU that serves or hosts a candidate/target cell, such as the DU 216 in FIG. 2. In the following, the DU that performs method 800 may be referred to as a “candidate/target DU”, in order to distinguish said DU from a serving DU.

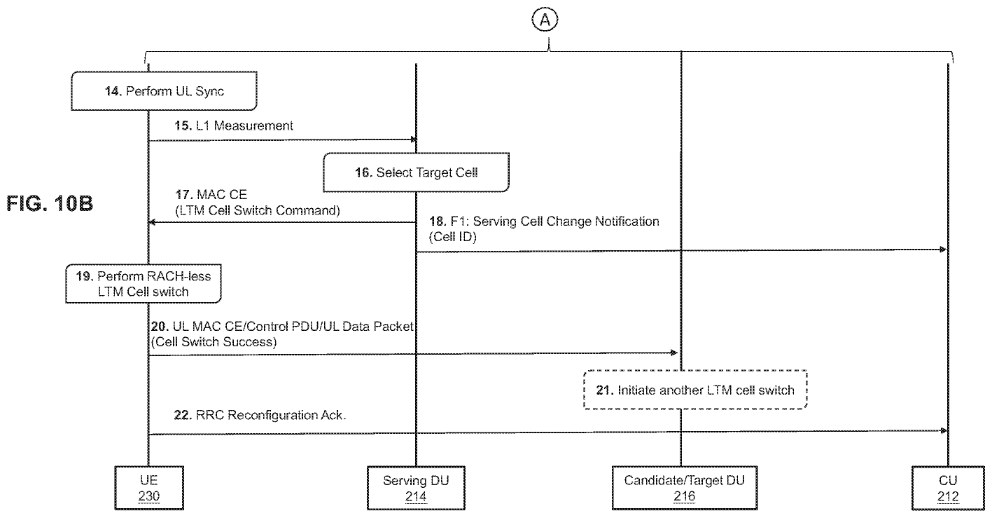

According to one or more embodiments, one or more operations of the method 800 may be triggered by a message or indication received by the candidate/target DU from a UE. A brief description of the triggering of the method 800 is provided in the following, and further descriptions associated therewith are provided below with reference to example use case in FIG. 10A.

Specifically, before the execution of the method 800, the UE may communicate with the candidate/target DU for UL synchronization. As described above, in order to enable the UE 230 to perform the RACH-less LTM cell switch, the UE 230 is required to be synchronized with the associated candidate cell(s). Thus, upon deciding to perform a RACH-less LTM cell switch when required, a serving DU may send a message or an instruction to the UE to request the UE to synchronize with the candidate cell(s) associated with the candidate/target DU and to acquire the timing advance (TA) associated therewith.

The TA defines a time difference between a timing when the UE transmits a signal to the candidate cell(s) (and/or the candidate/target DU) and a timing when the signal reaches the candidate cell(s) (and/or the candidate/target DU), and is used to control the UL transmission timing of the UE. The TA enables the UL synchronization of the UE with other devices (e.g., other UEs) that are connected to the same cell(s) or DU, such that the UL transmission of the UE can be synchronized with the UL transmission of other devices when being received by the candidate cell(s) (and/or the candidate/target DU). The message or instruction may include the Cell ID of the associated candidate cell(s). For descriptive purposes, it may be assumed that in the example of FIG. 2, the cells 226 and 228 are selected as the candidate cells for the RACH-less LTM cell switch.

As further described below in FIG. 10A, the UE may trigger one or more RACH procedures to synchronize with the associated candidate cells therefrom. According to one or more embodiments, the UE may send a RACH Preamble message to the candidate/target DU. The RACH Preamble message may include information to identify the UE (e.g., UE ID, subscriber number, etc.) and a request for TA(s) of the associated candidate cells. Further, the UE may provide the RACH Preamble message to the candidate/target DU via a Physical Random Access Channel (PRACH), and the RACH Preamble message may include a PRACH Preamble message.

Upon receiving a message or an indication for UL synchronization (e.g., upon receiving the RACH Preamble message, etc.), the candidate/target DU may initiate method 800. Example operations of the method 800 are described in the following.

Referring to FIG. 8, at operation S810, the candidate/target DU may be configured to provide at least one uplink (UL) grant to the UE. The at least one UL grant may enable or permit the UE to communicate with the candidate/target cell and/or the candidate/target DU, regardless of whether or not the candidate/target cell is configured with Cell DTX/DRX. According to one or more embodiments, the at least one UL grant may include at least one dynamic scheduling grant that allows the candidate/target cell(s) and/or the candidate/target DU to receive at least one specified message (e.g., an uplink MAC CE, a control PDU, and/or any other suitable layer 1/layer 2 message designated for the purpose of notifying the cell(s) and/or the DU) from the UE during the Cell DTX/DRX cycle of the candidate/target cell(s). Alternatively or additionally, the at least one UL grant may include at least one pre-configured grant that allows the candidate/target cell(s) and/or the candidate/target DU to receive at least one specified message during the Cell DTX/DRX cycle of the candidate/target cell(s).

According to one or more embodiments, the dynamic scheduling grant(s) and/or the pre-configured grant(s) may enable at least one PUCCH reception and/or at least one PUSCH reception at the candidate/target DU and/or at the candidate/target cell(s), during the non-active duration of the Cell DTX/DRX cycle of the candidate/target cell(s) (i.e., when the candidate/target cell(s) is in the sleep mode). In this regard, the dynamic scheduling grant(s) may be determined, computed, adjusted, or the like, by the candidate/target DU 216 in real-time (or near real-time) based on the current (or the last known) Cell DTX/DRX configuration of the candidate/target cell(s) and/or a UL scheduling request sent by the UE, while the pre-configured grant(s) may be predefined, predetermined, and provided by the candidate/target cell(s) to the UE beforehand.

According to one or more embodiments, the candidate/target DU may be configured to provide or assign the at least one UL grant in a Random Access Response (RAR) message, which is the response sent by the candidate/target DU after receiving the RACH Preamble message. The RAR message may include, in addition to the at least one UL grant, a Random Access Preamble identifier corresponding to the transmitted RACH Preamble, a temporary identity (e.g., Radio Network Temporary Identifier (RNTI), etc.), and the like. According to one or more embodiments in which the at least one UL grant includes the pre-configured grant, the candidate/target DU may be configured to obtain, from the candidate/target cell(s), the information of the pre-configured grant, and then include the information of the pre-configured grant in the LTM candidate cell configuration. Accordingly, the candidate/target DU may provide, to the UE via the CU, the pre-configured grant. According to embodiments, the candidate/target DU may also provide the at least one UL grant (e.g., dynamic scheduling grant, etc.) to the serving DU via the CU, and the serving DU may provide the at least one UL grant to the UE accordingly. Additionally or alternatively, the at least one UL grant (e.g., the pre-configured grant, etc.) may be provided to the CU, and the CU may include the at least one UL grant into the LTM configuration of the associated cell and then provide the same to the UE via RRC signaling (e.g., RRC Reconfiguration message, etc.).

According to one or more embodiments, the RACH Preamble message provided by the UE may include a Random Access RNTI (RA-RNTI). In this regard, the candidate/target DU may send the RAR message by including the RAR message (or the contents thereof) in a Downlink Control Information (DCI) and then scrambling the DCI with the RA-RNTI. In this way, the UE may obtain the RAR message by detecting and descrambling the DCI (from the Physical Downlink Control Channel (PDCCH)), and then obtain the information of the at least one UL grant therefrom.

Referring still to FIG. 8, upon providing the at least one UL grant to the UE, the method 800 may proceed to operation S820, at which the candidate/target DU may be configured to receive at least one notification of a successful LTM cell switch from a serving cell to the candidate/target cell.

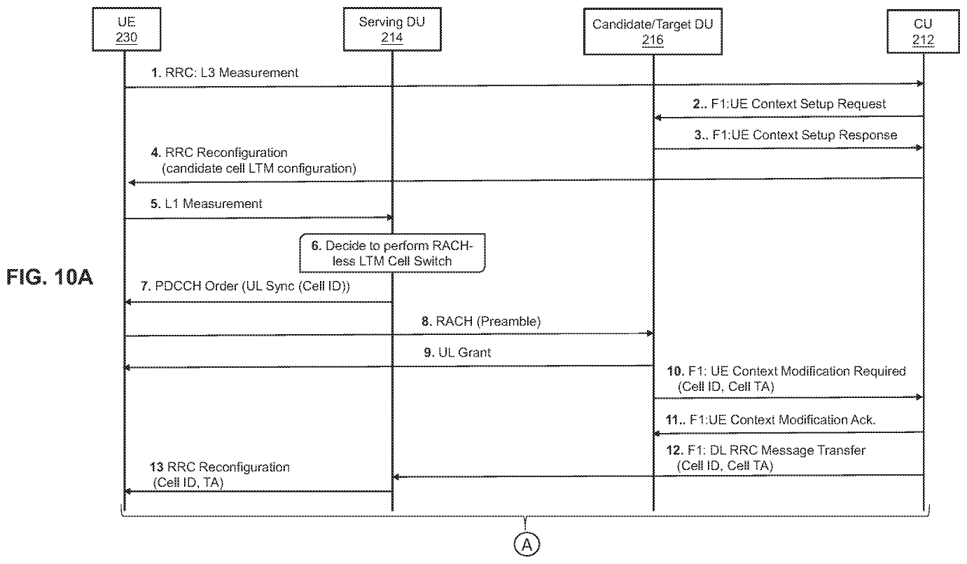

As further described below with reference to FIG. 9 and FIG. 10B, by allocating or providing at least one UL grant (e.g., at least one dynamic scheduling grant, at least one pre-configured grant, etc.) to the UE, the UE may send a message or an indication to the candidate/target cell and/or the candidate/target DU (which are the new serving cell and new serving DU, upon successful LTM cell switch) for notification of the successful LTM cell switch from the serving cell to the candidate/target cell, regardless of the Cell DTX/DRX configuration at said candidate/target cell. Namely, the UE may send, during a non-active duration of the Cell DTX/DRX cycle of the candidate/target cell (i.e., when the candidate/target cell is supposed to enter sleep mode), at least one L1/L2 message or an indication to the candidate/target cell and/or the candidate/target DU for notifying the successfully LTM cell switch. Alternatively or additionally, the old serving DU may also send an F1 message to the new serving DU, via the CU, indicating transmission of the LTM cell switch command in DL to the UE. A successful LTM cell switch execution indication can be initiated by the old serving DU, if the UE is configured with Dual Active Protocol Stack (DAPS) feature or multi transmission/reception point (mTRP) feature and sends an LTM cell switch execution notification to the serving DU.

According to one or more embodiments, the notification may be sent by the UE in the form of a MAC CE, a control Protocol Data Unit (PDU), and/or any other suitable Layer 1 (L1)/Layer 2 (L2) data/command/message dedicated for the purpose of notifying about the successful LTM cell switch. In this regard, at operation S820, the candidate/target cell and/or the candidate/target DU may monitor the Physical Uplink Control Channel (PUCCH) to receive one or more of said MAC CE, said control PDU, and said L1/L2 data/command/message. Alternatively or additionally, the notification may be sent by the UE in the form of a UL data packet. In this regard, at operation S820, the candidate/target cell may monitor the Physical Uplink Shared Channel (PUSCH) to receive said UL data packet.

According to one or more embodiments, in addition to or in alternative to the candidate/target DU, the serving DU may also perform one or more operations to enable the UE to send a message or an indication to the candidate/target cell and/or the candidate/target DU for notification of the successful LTM cell switch from the serving cell to the candidate/target cell.

As further described below with reference to FIG. 10B, during the LTM execution phase, the serving DU may receive one or more L1 measurements from the UE and then detect/select a target cell from among one or more LTM candidate cells. In this regard, upon selecting the target cell, the serving DU may provide information of the target cell (e.g., energy saving configuration, etc.) to the CU. The serving DU may obtain the information of the target cell (e.g., energy saving configuration, etc.) from the received L1 measurement(s), and then provide said information in any suitable message to the CU (via the F1 interface).

Accordingly, the CU may determine, based on the information of the target cell (e.g., energy saving information, etc.), whether or not the Cell DTX/DRX has been enabled at the target cell. Further, based on determining that the Cell DTX/DRX has been enabled at the target cell, the CU may provide a message or an instruction to the target cell and/or the target DU, such that the Cell DTX/DRX at the target cell can be temporarily deactivated (e.g., deactivated for at least a predefined period of time), thereby allowing the UE to send a UL data packet to the target cell for notification of the successful LTM cell switch.

To this end, the LTM cell switch is completed and the target cell may start serving or hosting the UE. Accordingly, the target cell and/or the target DU (which is now the new serving cell and the new serving DU) may initial one or more LTM cell switch procedures (e.g., one or more procedures described above with reference to the LTM preparation phase and the LTM execution phase), when required.

FIG. 9 illustrates operations on the UE side, according to an example embodiment. Specifically, FIG. 9 illustrates a flow diagram of an example method 900 for providing at least one notification of a successful LTM cell switch during an LTM execution phase, according to one or more embodiments. One or more operations of method 900 may be performed by a user equipment (UE), such as the UE 230 in FIG. 2. The UE may be configured with LTM, and may be communicatively coupled to a serving cell associated with a serving DU and a candidate/target cell associated with a candidate/target DU.

Referring to FIG. 9, at operation S910, the UE may be configured to receive at least one UL grant. Specifically, the UE may receive the at least one UL grant from the candidate/target DU (via an RAR message), the serving DU (via a DL message), and/or the CU (via an RRC message). The at least one UL grant may enable or permit the UE to communicate with the candidate/target cell and/or the candidate/target DU, regardless of whether or not the candidate/target cell is configured with Cell DTX/DRX. As described above with reference to operation S810 of the method 800, the candidate/target DU may provide at least one UL grant (e.g., at least one dynamic scheduling grant and/or at least one pre-configured grant) in, for example, an RAR message, in response to a RACH Preamble message provided by the UE. The RAR message may be included in a DCI that is scrambled based on the RA-RNTI included in the RACH Preamble message. In this regard, at operation S910, the UE may monitor the PDCCH to obtain the scrambled DCI, and then descramble the scrambled DCI to obtain RAR message that includes the at least one UL grant therefrom. According to one or more embodiments, the UE may obtain a System Information Block (SIB) from the broadcast channel, and then determine an RAR-window based on one or more IEs in the SIB (e.g., rar-WindowLength IE). Accordingly, the UE may monitor the PDCCH for the scrambled DCI within the duration defined by the RAR-window. It is contemplated that the UE may also receive the at least one UL grant from the serving DU and/or the CU, without departing from the scope of the present disclosure.

Upon receiving the at least one UL grant, the method 900 may proceed to operation S920, at which the UE may be configured to perform an LTM cell switch from the serving cell to a target cell. Specifically, upon receiving the UL grant from the candidate/target DU, the UE may send one or more L1 measurements to the serving DU. Accordingly, the serving DU may detect or select, based on the L1 measurement(s), the target cell from among one or more LTM candidate cells. Next, the serving DU may send an LTM cell switch command to the UE, and the UE may thereby perform the LTM cell switch based on the LTM cell switch command. Further descriptions of the associated operations are provided below with reference to FIG. 10B.

Upon successfully performing the LTM cell switch from the serving cell to the target cell, the method 900 may proceed to operation S930, at which the UE may be configured to provide, to the target cell and/or the target DU, at least one notification of the successful LTM cell switch from the serving cell to the target cell. Specifically, the UE may determine, based on the received UL grant(s), which type of notification(s) should be sent and the mean(s)/channel(s) for sending the notification(s).

According to one or more embodiments, the UE may send, to the target cell and/or the target DU via the PUCCH, at least one MAC CE, at least one control PDU, and/or any other suitable L1/L2 data/command/message, for notifying the target cell and/or the target DU on the successful LTM cell switch. Alternatively or additionally, the UE may send, to the target cell and/or the target DU via the PUSCH, at least one UL data packet for notifying the target cell and/or the target DU on the successful LTM cell switch. According to one or more embodiments, one or more of the MAC CE(s), the control PDU(s), and the UL data packet(s) may include a placeholder or an empty message that does not carry any significant data payload.

According to one or more embodiments, the operation S910 may be optional. Specifically, in some embodiments, the serving DU may interoperate with the CU to temporarily deactivate/disable the Cell DTX/DRX at the target cell. Specifically, upon selecting the target cell, the serving DU may provide information of the target cell (e.g., energy saving configuration, etc.) to the CU. The serving DU may obtain the information of the target cell (e.g., energy saving configuration, etc.) from at least one L1 measurement provided by the UE, and then provide said information in any suitable message to the CU (via the F1 interface).

Accordingly, the CU may determine, based on the information of the target cell (e.g., energy saving information, etc.), whether or not the Cell DTX/DRX has been enabled at the target cell. Further, based on determining that the Cell DTX/DRX has been enabled at the target cell, the CU may provide, a message or an instruction to the target cell and/or the target DU, such that the Cell DTX/DRX at the target cell can be temporarily deactivated (for at least a predefined period of time), thereby allowing the UE to send a UL data packet to the target cell and/or the target DU for notification of the successful LTM cell switch when required. As a result, the UE may provide the notification of the successful LTM cell switch to the target cell and/or the target DU, without requiring the aforesaid dynamic scheduling grant and the aforesaid pre-configured grant, since the target cell may pause the Cell DTX/DRX and act as a target cell that does not configured or enabled with Cell DTX/DRX.

In some implementations, the operations of the method 800 and the method 900 may be performed in any possible sequence. Example embodiments associated therewith are described in the following with reference to FIG. 10A and FIG. 10B.

FIG. 10A and FIG. 10B illustrate a flow sequence of an example use case of an LTM execution phase that involves the operations in the method 800 and the method 900, according to one or more embodiments. The flow sequence may involve at least one CU, at least one serving DU, at least one candidate/target DU, and at least one UE. According to one or more embodiments, the at least one UE may be configured with LTM, and one or more cells being hosted or served by the at least one candidate/target DU may be configured with Cell DTX/DRX.

For descriptive purposes, the example embodiment of FIG. 10A and FIG. 10B is illustrated as involving the CU 212, the serving DU 214 (and the cells associated therewith), the candidate/target DU 216 (and the cells associated therewith), and the UE 230, described above with reference to FIG. 2. Further, for descriptive purposes, some operations in FIG. 10 may also be described with reference to one or more of FIG. 2 to FIG. 9, along with one or more non-exhaustive assumptions or example conditions.

Referring to FIG. 10A, at step 1, the UE 230 may provide, to the CU 212, one or more L3 measurements. Accordingly, at step 2, the CU 212 may provide, to the candidate/target DU 216 via the F1 interface, a UE Context Setup Request message. Subsequently, at step 3, the candidate/target DU 216 may provide, to the CU 212 via the F1 interface, a UE Context Setup Response message.

Steps 1 to 3 in FIG. 10A may define the operations of the LTM preparation phase, and may be similar to one or more steps in FIG. 6 and FIG. 7. For instance, step 1 in FIG. 10A may be similar to or may involve step 1 in FIG. 6 and FIG. 7, step 2 in FIG. 10A may include steps 2 to 3 in FIG. 6 and FIG. 7, and step 3 in FIG. 10A may include steps 4 to 5 in FIG. 6 and step 4 in FIG. 7. In this regard, it may be understood that steps 1 to 3 in FIG. 10A are not limited only to the embodiments in FIG. 6 and FIG. 7 (which are related to the preparation of one or more inter-frequency LTM candidate cells), and may also involve operations associated with the preparation of one or more intra-frequency LTM candidate cells, or the preparations of a combination of intra-frequency LTM candidate cell(s) and inter-frequency candidate cell(s), without departing from the scope of the present disclosure.

At step 4, the CU 212 may prepare and provide LTM configuration of at least one LTM candidate cell to the UE 230. The at least one LTM candidate cell may include at least one intra-frequency cell, at least one inter-frequency cell, or a combination thereof. Said LTM configuration may be provided, by the CU 212 via RRC interface, in at least one RRC Reconfiguration message.

Upon receiving the LTM configuration of the LTM candidate cell(s), at step 5, the UE 230 may perform one or more L1 measurements on the LTM candidate cell(s) and/or the serving cell, and then provide/report the L1 measurement(s) to the serving DU 214, thereby triggering the LTM cell switch when applicable. For instance, the UE 230 may continuously (or periodically) perform one or more L1 measurements on the one or more LTM candidate cells (e.g., cells 226-228 in FIG. 2), and may send the results of the one or more L1 measurements (e.g., in the form of L1 measurement report(s), etc.) to the serving DU 214.

Upon receiving the L1 measurement(s), at step 6, the serving DU 214 may determine, based on the L1 measurement(s), which type of LTM cell switch should be performed when required (e.g., when one or more cell switch criteria are met). Specifically, the serving DU 214 may determine whether the UE 230 should perform a RACH-based LTM cell switch or a RACH-less LTM cell switch to the candidate cell(s) when required.

According to one or more embodiments, the serving DU 214 may prioritize the RACH-less LTM cell switch over the RACH-based LTM cell switch. For instance, the serving DU 214 may first determine whether or not the UE 230 may perform a RACH-less LTM cell switch, and then determine whether or not the UE may perform a RACH-based LTM cell switch when it is determined that the UE may not perform the RACH-less LTM cell switch.

For descriptive purposes, it may be assumed that in the example of FIG. 10A, the serving DU 214 has decided that a RACH-less LTM cell switch should be performed when the LTM cell switch is required. Accordingly, at step 7, the serving DU 214 may send a message or an instruction to the UE 230 to request the UE to perform UL synchronization with the LTM candidate cell(s) that may be involved in the RACH-less LTM cell switch, and request the UE to acquire TA of said LTM candidate cell(s).

According to one or more embodiments, the serving DU 214 may request or inform the UE 230 to synchronize with the associated LTM candidate cell(s) and to acquire the associated TA, by triggering a PDCCH Order. In this case, the serving DU 214 may send, for example, a DCI message (e.g., DCI Format 1_0, etc.) that includes a request for UL synchronization and the Cell ID(s) of the associated LTM candidate cell(s), to the UE.

Subsequently, at step 8, the UE 230 may trigger one or more RACH procedures to attempt UL synchronization with the associated LTM candidate cell(s) therefrom. According to one or more embodiments, the UE 230 may send a RACH Preamble message to the candidate/target DU 216 that hosts or servers the LTM candidate cell(s). The RACH Preamble message may include information to identify the UE 230 (e.g., UE ID, subscriber number, etc.) and a request for TA(s) of the LTM candidate cell(s). Further, the UE 230 may provide the RACH Preamble message to the candidate/target DU 216 via a Physical Random Access Channel (PRACH), and the RACH Preamble message may include a PRACH Preamble message.

Upon receiving a message or a request for UL synchronization (e.g., upon receiving the RACH Preamble message), at step 9, the candidate/target DU 216 may allocate at least one UL grant to the UE 230. As described above with reference to operation S810 in the method 800, the candidate/target DU 216 may provide at least one dynamic scheduling grant, at least one pre-configured grant, or a combination thereof, to the UE 230 (e.g., via an RAR message) in response to the RACH Preamble message provided by the UE 230 at step 8. Additionally or alternatively, the candidate/target DU may provide the at least one UL grant to the CU 212 and/or the serving DU 214, and the CU 212 and/or the serving DU 214 may route the at least one UL grant to the UE 230 accordingly.

Further, at step 10, the candidate/target DU 216 may initiate a UE context modification procedure. For instance, the candidate/target DU 216 may provide, to the CU 212 via F1 interface, a UE Context Modification Required message that includes the information of the LTM candidate cell(s), such as the Cell ID(s) and the Cell TA(s). Upon receiving the UE Context Modification Required message from the candidate/target DU 216, at step 11, the CU 212 may provide, to the candidate/target DU 216 via the F1 interface, a UE Context Modification Acknowledge message to acknowledge the receipt of the UE Context Modification Required message.

Furthermore, at step 12, the CU 212 may provide the information of the LTM candidate cell(s), such as the Cell ID(s) and the Cell TA(s), to the serving DU 214. According to one or more embodiments, the CU 212 may provide, to the serving DU 214 via F1 interface, a downlink (DL) RRC Message Transfer message that includes a RRC Reconfiguration message, wherein the RRC Reconfiguration message may include the information of the Cell ID(s) and the Cell TA(s). Accordingly, at step 13, the serving DU 214 may forward the RRC Reconfiguration message to the UE 230. According to one or more embodiments, in addition to the RRC Reconfiguration message, the DL RRC Message Transfer message may also include the information of the Cell ID(s) and the Cell TA(s). In this way, the serving DU 214 may also obtain the information of the LTM candidate cell(s), such as the associated Cell ID(s) and Cell TA(s), and may thereby perform one or more operations (e.g., perform synchronization with the candidate/target DU 216, resend the information of the Cell ID(s) and/or Cell TA(s) to the UE 230, etc.) when required.

Referring next to FIG. 10B, at step 14, the UE 230 may perform one or more UL synchronization operations based on the information of the LTM candidate cell(s) (e.g., information included in the RRC Reconfiguration message provided by the serving DU 214 at step 13). For instance, the UE 230 may adjust, based on the Cell TA(s), one or more timing settings (e.g., timing for UL signal transmission, etc.), thereby synchronizing with the LTM candidate cell(s).

Subsequently, at step 15, the UE 230 may perform one or more L1 measurements on the LTM candidate cell(s), and then report the L1 measurement(s) to the serving DU 214 (in the form of one or more measurement reports). According to one or more embodiments, when reporting the L1 measurement, the UE 230 may also notify the serving DU 214 regarding the successful synchronization with the LTM candidate cell(s), as requested by the serving DU 214 (at step 7).

Upon receiving the L1 measurement(s) from the UE 230, at step 16, the serving DU 214 may determine whether or not the LTM cell switch is required based thereon. Specifically, the serving DU 214 may determine, based on one or more parameters (e.g., RSRP, SINR, etc.) in the L1 measurement(s), whether or not one or more criteria for performing the RACH-less LTM cell switch (may be referred to as “cell switch criteria” herein) are met. For instance, the serving DU 214 may determine, based on one or more parameters in the one or more L1 measurements, whether or not the signal quality of the serving cell is deteriorating, whether or not an LTM candidate cell offers a better signal quality, and the like.

According to one or more embodiments, based on determining that the LTM cell switch is required, the serving DU 214 may select, from among the available LTM candidate cells, a target cell for the LTM cell switch. In some implementations, the serving DU 214 may select an LTM candidate cell that can be switched via the RACH-less LTM cell switch as the primary target cell, and may select an LTM candidate cell that can be switched via the RACH-based LTM cell switch as the secondary target cell. Further, if multiple LTM candidate cells are available for the RACH-less LTM cell switch, the serving DU 214 may select the target cell from among said multiple LTM candidate cells. For instance, the serving DU 214 may select the LTM candidate cell based on determining which candidate cell can provide a better signal quality, which candidate cell has been previously selected as the target cell in a previous LTM cell switch, and the like.

Upon selecting the target cell, at step 17, the serving DU 214 may generate and provide an LTM cell switch command to the UE 230 to instruct the UE 230 to perform the LTM cell switch from the serving cell to the selected target cell (e.g., target cell 228). According to one or more embodiments, the serving DU 214 may provide the LTM cell switch command in a MAC CE. The LTM cell switch command may include configurations of the selected target cell.

Upon providing the LTM cell switch command to the UE 230, at step 18, the serving DU 214 may send a message or an indication to the CU 212 to notify the CU 212 regarding the information of the selected target cell. According to one or more embodiments, the serving DU 214 may provide, to the CU 212 via the F1 interface, a Serving Cell Change Notification message including the Cell ID of the selected target cell.

On the other hand, upon obtaining the LTM cell switch command from the serving DU 214, at step 19, the UE 230 may perform, based on the LTM cell switch command, an LTM cell switch from the serving cell to the target cell. In the example of FIG. 10B, it may be assumed that, at step 19, the UE 230 may perform a RACH-less LTM cell switch. For instance, the UE 230 may detach from the serving cell and may apply the LTM configuration of the target cell.

Upon successful LTM cell switch, at step 20, the UE 230 may provide, to the target cell and/or the candidate/target DU 216 (i.e., the new serving cell and the new serving DU), at least one notification of the successful LTM cell switch. As described above with reference to FIG. 8 and FIG. 9, in some embodiments, the UE may send, to the target cell and/or the target DU 216 via the PUCCH, at least one MAC CE, at least one control PDU, and/or any other suitable L1/L2 data/command/message, for notifying the target cell and/or the target DU 216 on the successful LTM cell switch. Alternatively or additionally, the UE may send, to the target cell and/or the target DU 216 via the PUSCH, at least one UL data packet for notifying the target cell and/or the target DU 216 on the successful LTM cell switch. According to one or more embodiments, one or more of the MAC CE(s), the control PDU(s), and the UL data packet(s) may include a placeholder or an empty message that does not carry any significant data payload. In addition, if the serving DU 214 and the CU 212 have interoperated to temporarily deactivate/disable the Cell DTX/DRX at the target cell, the UE 230 may provide the notification of the successful LTM cell switch (e.g., a UL data packet, etc.) to the target cell and/or the target DU 216.

Upon receiving the notification of the successful LTM cell switch, the LTM cell switch procedure may be completed and the target cell and the target DU 216 may now act as the new serving cell and the new serving DU that start serving the UE 230. For instance, at step 21, the DU 216 may initiate another LTM cell switch(s), if required.

On the other hand, upon sending the notification of the successful LTM cell switch to the DU 216, at step 22, the UE 230 may also send an acknowledgment message to the CU 212. For instance, the UE 230 may provide, to the CU 212 via the RRC interface, an RRC Reconfiguration Acknowledgment message (e.g., RRC Reconfiguration Complete message, etc.) to notify the CU 212 about the successful LTM cell switch.

It is contemplated that the example operations and use cases described above with reference to FIG. 8 to FIG. 10B are merely examples, and should not limit the scope of the present disclosure by any means. Specifically, one or more operations described above may include more/fewer steps, may be performed in a different sequence, and the like, without departing from the scope of the present disclosure.

In view of the above, example embodiments of the present disclosure provide systems, methods, devices, and the like, that effectively and efficiently facilitate LTM interworking with Cell DTX/DRX at a target cell, during the LTM execution phase.

Specifically, example embodiments provide at least one UL grant to the UE in various ways and/or temporarily deactivate the Cell DTX/DRX at the target cell, thereby enabling the UE to effectively and efficiently report or provide at least one notification of a successful LTM cell switch to the network (i.e., the target cell and/or the target DU), even if the target cell is configured with Cell DTX/DRX. Accordingly, network resources may be conserved since unnecessary further LTM cell switch(es) can be avoided, and the ping-pong phenomenon described above may be efficiently avoided. Ultimately, example embodiments of the present disclosure enable an efficient and effective LTM execution phase, even if the target cell involved in the LTM execution phase is configured with Cell DTX/DRX.

### Examples of Network Node

As described above, according to one or more embodiments, the central unit (CU) and distributed units (DUs) may be defined in a software form and deployed in one or more network nodes (e.g., server nodes, etc.). In the following, descriptions of example network nodes are provided with reference to FIG. 11 and FIG. 12.

FIG. 11 illustrates a block diagram of example components of a network node 1100, according to one or more embodiments. Network node 1100 may include one or more servers in which the CU and/or the DUs of example embodiments may be implemented or deployed. According to one or more embodiments, the network node 1100 may include an edge server or an edge node. Additionally or alternatively, the network node 1100 may include a central server or a central node.

As illustrated in FIG. 11, the network node 1100 may include at least one communication interface 1110, at least one storage 1120, and at least one processor 1130, although it can be understood that the network node 1100 may include more or less components than as illustrated in FIG. 11, and/or may be arranged in a manner different from as illustrated in FIG. 11, without departing from the scope of the present disclosure.

The communication interface 1110 may include at least one transceiver-like component (e.g., a transceiver, a separate receiver and transmitter, a bus, etc.) that enables the components of the server node 1100 to communicate with each other and/or to communicate with one or more components external to the network node 1100, such as via a wired connection, a wireless connection, or a combination of wired and wireless connections.

According to one or more embodiments, the communication interface 1110 may include at least one transmitter, at least one receiver, and at least one antenna. The at least one transmitter may be configured to transmit data/information to one or more external nodes/devices using the antenna, and the at least one receiver may be configured to receive data/information from the one or more external nodes/devices using the antenna. The at least one transmitter and the at least one receiver may be collectively implemented as a single transceiver module.

For instance, the communication interface 1110 may couple the processor 1130 to the storage 1120, thereby enabling them to communicate and interoperate with each other in performing one or more operations. As another example, communication interface 1110 may couple the network node 1100 (or one or more components included therein) to one or more network elements (e.g., a network cell, a UE, etc.), so as to enable them to communicate and interoperate with each other.

According to one or more embodiments, the communication interface 1110 may include one or more application programming interfaces (APIs) that allow the network node 1100 (or one or more components included therein) to communicate with one or more software applications (e.g., software application deployed in UE, virtualized network function(s), etc.).

According to one or more embodiments, the communication interface 1110 may include at least one input/output (I/O) interface, at least one network interface, and at least one storage interface.

According to one or more embodiments, the I/O interface may employ communication protocols/methods such as, without limitation, audio, analog, digital, stereo, IEEE-1393, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), and the like. Via the I/O interface, the network node 1100 may communicate with at least one input device (e.g., a keyboard, a mouse, a touch screen, sensors, microphones, scanners, a camera, a fingerprint scanner, etc.) and at least one output device (e.g., a speaker, an electronic screen, etc.).

According to one or more embodiments, the network interface may employ connection protocols including, without limitation, direct connection, Ethernet (e.g., twisted pair 10/100/1000 Base T), Transmission Control Protocol/Internet Protocol (TCP/IP), token ring, IEEE 802.11a/b/g/n/x, etc. The network node 1110 may be disposed to or in communication with a network via the network interface. Descriptions of example networks are provided below with reference to network 1330 of FIG. 13.

According to one or more embodiments, the storage interface may employ connection protocols including, without limitation, Serial Advanced Technology Attachment (SATA), Integrated Drive Electronics (IDE), IEEE-1393, Universal Serial Bus (USB), fiber channel, Small Computer Systems Interface (SCSI), and the like. The storage interface may connect one or more components of the server node 1100 (e.g., processor 1120) to the storage 1120.

Referring still to FIG. 11, the storage 1120 may include one or more storage mediums suitable for storing data, information, and/or computer-executable instructions therein. According to one or more embodiments, the storage 1120 may include at least one memory storage, such as a random access memory (RAM), a read-only memory (ROM), and/or another type of dynamic or static storage device (e.g., a flash memory, a magnetic memory, and/or an optical memory) that stores information and/or instructions for use by the processor 1130. Further, the storage 1120 may further include a drum, magnetic disc drive, magneto-optical drive, optical drive, Redundant Array of Independent Discs (RAID), solid-state memory devices, solid-state drives, and the like. Further descriptions of the memory are provided with reference “computer-readable medium” described herein.

Additionally or alternatively, the storage 1120 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to one or more embodiments, the storage 1120 may act as a database, which may be implemented as a fault-tolerant database, a relational database, a scalable database, and a secure database. In this case, the storage 1120 may include, for example, Oracle or Sybase.

According to one or more embodiments, the storage 1120 may be configured to store information, such as raw data, metadata, or the like, obtained from one or more nodes. Additionally or alternatively, the storage 1120 may be configured to store one or more information associated with one or more operations performed by the processor 1130. For instance, the storage 1120 may store one or more results produced or generated by the at least one processor 1130, may store information of network entities (e.g., network cells, UE, etc.) involved in the operation(s) performed by the processor 1130, information of historical operations performed by the processor 1130, and/or the like.

According to one or more embodiments, the storage 1120 may store the software-based CU and/or the software-based DUs, as well as one or more information associated therewith (e.g., computer-readable instructions for implementing the software-based CU/software-based DUs, etc.). For instance, the network node 1100 may include a cloud server and the CU and/or DUs may be defined in the form of a cloud-native application that runs on top of at least one OS in the cloud server.

Furthermore, the storage 1120 may include a memory or a storage medium storing a collection of program or database components, such as a user interface, an operating system, a web browser, and/or the like.

The user interface may facilitate display, execution, interaction, manipulation, or operation of program components through textual or graphical facilities. For example, one or more user interfaces may provide computer interaction interface elements on a display system operatively connected to the network nodes 1100, such as cursors, icons, checkboxes, menus, scrollers, windows, widgets, and the like. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like. In some implementations, the storage 1120 may include a plurality of storage mediums, and the storage 1120 may be configured to store a duplicate or a copy of at least a portion of the information in the plurality of storage mediums, for providing redundancy and for backing-up the information or the associated data.

The operating system may facilitate resource management and operation of the network node 1100. Examples of operating systems may include, without limitation, APPLE® MACINTOSH® OS X®, UNIX®, UNIX-like system distributions (e.g., BERKELEY SOFTWARE DISTRIBUTION® (BSD), FREEBSD®, NETBSD®, OPENBSD, etc.), LINUX® DISTRIBUTIONS (e.g., RED HAT®, UBUNTU®, KUBUNTU®, etc.), IBM®OS/2®, MICROSOFT® WINDOWS® (XP®, VISTA®/7/8, 10, 11, etc.), APPLE® IOS®, GOOGLE™ ANDROID™, BLACKBERRY® OS, or the like.

The web browser may be a hypertext viewing application, such as MICROSOFT® INTERNET EXPLORER®, MICROSOFT® EDGE®, GOOGLE™, CHROME™, MOZILLA® FIREFOX®, APPLE® SAFARI®, and the like. Secure web browsing may be provided using Secure Hypertext Transport Protocol (HTTPS), Secure Sockets Layer (SSL), Transport Layer Security (TLS), and the like. Further, the web browser may utilize facilities such as AJAX, DHTML, ADOBE® FLASH®, JAVASCRIPT®, JAVAR, Application Programming Interfaces (APIs), and the like.

Referring still to FIG. 11, the processor 1130 may include at least one processor capable of being programmed or configured to perform a function(s) or an operation(s) described herein. According to one or more embodiments, the processor 1130 may be configured to receive (e.g., via the communication interface 1110, etc.) one or more signals and/or instructions for triggering the performing of one or more operations.

Further, the processor 1130 may be implemented in hardware, firmware, or a combination of hardware and software. For instance, the processor 1130 may include at least one generic or specialized processing unit, such as at least one of: a central processing unit (CPU), a graphics processing unit (GPU), an accelerated processing unit (APU), a microprocessor, a microcomputer, a state machine, a logic circuit, a microcontroller, a digital signal processor (DSP), a field-programmable gate array (FPGA), an application-specific integrated circuit (ASIC), an integrated system (bus) controller, a memory management control unit, a floating point unit, a digital signal processing unit, and/or another type of processing or computing unit.

According to one or more embodiments, the processor 1130 may be configured to execute the software-based CU and/or the software-based DUs (or computer-executable instructions for implementing the CU and/or the DUs) stored in at least one storage medium or memory storage (e.g., storage 1120, etc.) to thereby perform one or more actions or one or more operations described herein.

In some embodiments, the network node 1100 may implement a mail server-stored program component. The mail server may be an Internet mail server such as MICROSOFT® EXCHANGE®, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, and the like. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the server node 1100 may implement a mail client stored program component. The mail client may be a mail-viewing application, such as APPLE® MAIL, MICROSOFT® ENTOURAGE®, MICROSOFT® OUTLOOK®, MOZILLA® THUNDERBIRD®, and the like.

Although the example embodiment in FIG. 11 is described with reference to network node for hosting or deploying a CU and/or a DUs, it can be understood that the network node 1100 may also refer to a UE. Specifically, the UE may also include at least one communication interface, at least one storage, and at least one processor. In this regard, it is contemplated that one or more operations associated with the UE as described herein may be performed by, for example, the at least one processor upon executing instructions stored in the at least one storage and/or received via the communication interface, and the like, without departing from the scope of the present disclosure.

According to one or more embodiments, the CU and/or the DUs (or one or more operations associated therewith) may be implemented in the form of a containerized network function, according to one or more embodiments. Below, descriptions of an example configuration for implementing the containerized functions are provided.

FIG. 12 illustrates a block diagram of an example configuration of a network node 1200, according to one or more embodiments. The network node 1200 may correspond to the network node 1100 in FIG. 11, and may be configured to implement one or more server platforms (descriptions of example embodiment associated therewith are provided below with reference to FIG. 13).

According to one or more embodiments, the CU and/or the DUs (or one or more operations associated therewith) may be defined in software form via, for example, containerization (or any other suitable technology). Accordingly, the containerized CU and/or the containerized DUs may be deployed, in the form of containers, in the network node 1200, and the functionalities/operations associated with the CU/DUs may be performed via execution or orchestration of the containers associated therewith.

As illustrated in FIG. 12, the network node 1200 may include a plurality of containers 1211-1212 and 1221-1222. The containerized CU and/or the containerized DUs may be disaggregated or scattered among the plurality of containers 1211-1212 and 1221-1222. For instance, the functionalities or operations of the DUs may be scattered among the containers 1211-1212, while the functionalities or operations of the CU may be scattered among the containers 1221-1222.

Additionally or alternatively, the containerized CU and/or the containerized DUs may be segregated according to the type of operations. For instance, the functionalities or operations associated with a UE may be scattered among the containers 1211-1212, while the functionalities or operations associated with the CU and the DUs may be scattered among the containers 1221-1222. As another example, the functionalities or operations associated with Cell DTX/DRX may be scattered among the containers 1211-1212, while the functionalities or operations associated with LTM may be scattered among the containers 1221-1222.

According to one or more embodiments, the network node 1200 may include a Kubernetes (K8s) node, and the containers may be grouped or aggregated in a respective pod. In the example embodiment of FIG. 12, the containers 1211-1212 are included in a first pod 1210, while the containers 1221-1222 are included in a second pod 1220.

The plurality of pods in the network node 1200 may share the same resources (e.g., CPU, memory, etc.) provided by the network node 1200. The resources being allocated for facilitating and controlling the LTM interworking with Cell DTX/DRX at the target cell may be managed by adjusting the associated pods and/or containers. For instance, the resources may be scaled up by increasing the number of containers and/or pods associated therewith, may be scaled down by decreasing the number of containers and/or pods associated therewith, or the like.

It can be understood that the configuration illustrated in FIG. 12 is simplified for descriptive purposes, and is not intended to limit the scope of the present disclosure. Specifically, in practice, the network node 1200 may include any suitable components for hosting and executing a plurality of pods, while the number of pods may be greater than two and the number of containers included in each pod may be greater than two, without departing from the scope of the present disclosure. Further, it can be understood that the containerized CU and/or the containerized DUs (or the operations associated therewith) may be hosted or deployed in a plurality of network nodes, in a similar manner as described above. Furthermore, it can be understood that multiple nodes may include the same containers (or pods) in order to provide network redundancy thereby improving the network availability.

To this end, example embodiments of the present disclosure may provide one or more network nodes in which the CU and/or DUs of example embodiments may be implemented and deployed or be implemented. Accordingly, the one or more network nodes (or one or more processors associated therewith) may be configured to execute the CU and/or the DUs (or computer-executable instructions associated therewith) to perform one or more operations described herein, thereby facilitating LTM interworking with Cell DTX/DRX at the target cell.

Further, example embodiments of the present disclosure may leverage the advantages of containerization in facilitating LTM interworking with Cell DTX/DRX at the target cell. For instance, implementing containerized CU and/or containerized DUs (or operations associated therewith) offers improved scalability, since the functionalities may be efficiently scaled according to demand and may be easily replicated and orchestrated across multiple nodes, thereby enabling efficient resource utilization and seamless scaling.

Further, the containerized CU and/or containerized DUs (or operations associated therewith) may be quickly instantiated, migrated, and updated, allowing for faster time-to-market for new services and features. Furthermore, the functionalities of the CU and/or the DUs may be managed by adjusting the associated containers, thereby enabling independent development, testing, and deployment of the operations.

In addition, implementing containerized CU and/or containerized DUs (or operations associated therewith) may also improve resource utilization efficiency, utilize container-specific security features to improve the system security, provide improved portability and interoperability, and enable seamless integration with different systems or platforms.

### Example of Implementation Environment

As described above, according to one or more embodiments, the CU and/or the DUs (or operations associated therewith) may be implemented in one or more network nodes, which may include a cloud server or a cloud server cluster. Descriptions of an example cloud environment, in which the example embodiments may be implemented, are provided below with reference to FIG. 13.

FIG. 13 illustrates a diagram of an example environment 1300 in which the systems and/or methods described herein, may be implemented. As illustrated in FIG. 13, environment 1300 may include a plurality of nodes 1310, a server platform 1320, and a network 1330. Devices of environment 1300 may interconnect via wired connections, wireless connections, or a combination of wired and wireless connections.

The plurality of nodes 1310 may include one or more UEs and/or one or more network cells described hereinabove. Thus, redundant descriptions associated therewith may be omitted below for conciseness.

The network 1330 may include one or more wired and/or wireless networks. For example, the network 1330 may include a cellular network (e.g., a fifth generation (5G) network, a sixth generation (6G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks. Additionally or alternatively, the network 1330 may be implemented as one or more of various types of networks, such as intranet or Local Area Network (LAN), Closed Area Network (CAN), and the like. Further, the network 1330 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), and the like, to communicate with each other. Further, the network 1330 may include a variety of network devices, including routers, bridges, servers, computing devices, storage devices, and the like.

The server platform 1320 may include one or more servers capable of receiving, generating, storing, processing, and/or providing information. According to one or more embodiments, the server platform 140 may include one or more network nodes described above with reference to FIG. 11 and FIG. 12. In some implementations, server platform 1320 may include a cloud server or a group of cloud servers.

In some implementations, the server platform 1320 may be designed to be modular such that certain software components may be swapped in or out depending on a particular need. As such, the server platform 1320 may be easily and/or quickly reconfigured for different uses.

In some implementations, as shown, the server platform 1320 may be hosted in cloud computing environment 1322. Notably, while implementations described herein describe the server platform 1320 as being hosted in cloud computing environment 1322, in some implementations, platform 1320 may not be cloud-based (i.e., may be implemented outside of a cloud computing environment) or may be partially cloud-based.

Cloud computing environment 1322 includes an environment that hosts the server platform 1320. Cloud computing environment 1322 may provide computation, software, data access, storage, and services that do not require end-user knowledge of a physical location and configuration of system(s) and/or device(s) that hosts the server platform 1320. As shown, cloud computing environment 1322 may include a group of computing resources 1324 (referred to collectively as “computing resources 1324” and individually as “computing resource 1324”).

Computing resource 1324 may include one or more personal computers, a cluster of computing devices, workstation computers, server devices, or other types of computation and/or communication devices. In some implementations, the computing resource 1324 may host the server platform 1320. The cloud resources may include instances computing and executing in the computing resource 1324, storage devices provided in the computing resource 1324, data transfer devices provided by the computing resource 1324, and the like. In some implementations, the computing resource 1324 may communicate with other computing resources 1324 via wired connections, wireless connections, or a combination of wired and wireless connections.

As further shown in FIG. 13, the computing resource 1324 includes a group of cloud resources, such as one or more applications (“APPs”) 1324-1, one or more virtual machines (“VMs”) 1324-2, virtualized storage (“VSs”) 1324-3, one or more hypervisors (“HYPs”) 1324-4, or the like.

The application 1324-1 may include one or more software applications that may be provided to or accessed by the nodes 1310. The application 1324-1 may eliminate the need to install and execute the software applications on the node 1310. For example, the application 1324-1 may include software associated with the server platform 1320 and/or any other software capable of being provided via cloud computing environment 1322. In some implementations, one application 1324-1 may send/receive information to/from one or more other applications 1324-1, via virtual machine 1324-2.

The virtual machine 1324-2 may include a software implementation of a machine (e.g., a computer) that executes programs like a physical machine. Virtual machine 1324-2 may be either a system virtual machine or a process virtual machine, depending upon the use and degree of correspondence to any real machine by the virtual machine 1324-2. A system virtual machine may provide a complete system platform that supports the execution of a complete operating system (“OS”). Descriptions of examples of OS have been provided above with reference to FIG. 11. A virtual machine may execute a single program, and may support a single process. In some implementations, virtual machine 1324-2 may execute on behalf of a user (e.g., a user associated with the node(s) 1310), and may manage infrastructure and/or configuration of cloud computing environment 1322, such as data management, synchronization, or long-duration data transfers.

Virtualized storage 1324-3 may include one or more storage systems and/or one or more devices that use virtualization techniques within the storage systems or devices of computing resource 1324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1324-4 may provide hardware virtualization techniques that allow multiple operating systems (e.g., “guest operating systems”) to execute concurrently on a host computer, such as computing resource 1324. The hypervisor 1324-4 may present a virtual operating platform to the guest operating systems, and may manage the execution of the guest operating systems. Multiple instances of a variety of operating systems may share virtualized hardware resources.

It is contemplated that the number and arrangement of devices and networks shown in FIG. 13 are provided as an example. In practice, there may be additional devices and/or networks, fewer devices and/or networks, different devices and/or networks, or differently arranged devices and/or networks than those shown in FIG. 13. Furthermore, two or more devices shown in FIG. 13 may be implemented within a single device, or a single device shown in FIG. 13 may be implemented as multiple, distributed devices. Additionally, or alternatively, a set of devices (e.g., one or more devices) of environment 1300 may perform one or more functions described as being performed by another set of devices of environment 1300.

According to one or more embodiments, the CU and/or the DUs (or one or more operations associated therewith) described herein may be implemented or be deployed in the server platform 1320 described above, in the form of virtualized network function (VNF). In this regard, it is contemplated that the terms “virtual”, “virtualized”, or the like, described hereinabove are merely intended to specify the nature of the machine (and the elements and resources associated therewith) being provided in virtual or software form. In this regard, the “virtual machine”, “virtualized storage”, and the like, described hereinabove should not be limited to any specific type of virtual machine or virtual element. Accordingly, it can be understood that the CU and/or the DUs (or operations associated therewith) may be defined or presented in the form of a containerized network function, of which the functions may be provided in the form of containers. Descriptions of an example implementation configuration for implementing the (or operations associated therewith) in the form of a containerized function have been provided above with reference to FIG. 12.

To this end, by virtualizing and implementing the CU and/or the DUs (or operations associated therewith) in the server platform 1320, the resources (e.g., processing power, memory, storage, etc.) for facilitating the LTM interworking with Cell DTX/DRX at the target cell may be easily managed and be dynamically scaled up or scaled down on demand, which in turn optimize the resource allocation and utilization. Furthermore, said data and information associated with the CU and/or the DUs may be easily cloned or backed up to provide redundancy, and the access of said data and information may be authorized and authenticated to a trusted entity only.

### VARIOUS ASPECTS OF EMBODIMENTS

It is contemplated that the example embodiments described hereinabove with reference to FIG. 2 to FIG. 13 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., network node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A system that may include a distributed unit (DU) configurable to: determine, based on an active duration of a Cell Discontinuous Transmission (DTX)/Discontinuous Reception (DRX) cycle associated with an inter-frequency cell, an optimal measurement gap (MG); and provide, to a user equipment (UE), information of the optimal MG, wherein the information of the optimal MG may be utilized by the UE to perform an inter-frequency measurement.

Item [2]: The system according to item [1], wherein the DU may be configured to provide the information of the optimal MG by: receiving, from a central unit (CU), a UE Context Setup Request message to prepare a Layer 1/Layer 2 (L1/L2) Triggered Mobility (LTM) candidate cell for the UE; and providing, to the CU, a UE Context Setup Response message that includes the information of the optimal MG.

Item [3]: The system according to item [1], wherein the DU may be configured to provide the information of the optimal MG by: providing, to a central unit (CU), a UE Context Modification Required message that includes the information of the optimal MG.

Item [4]: The system according to item [2], wherein the system may further include the CU, and wherein the CU may be configured to: generate a Radio Resource Control (RRC) Reconfiguration message that includes the information of the optimal MG and configuration of the inter-frequency cell; and provide, to the UE, the RRC Reconfiguration message.

Item [5]: The system according to item [3], wherein the system may further include the CU, and wherein the CU may be configured to: generate a Radio Resource Control (RRC) Reconfiguration message that includes the information of the optimal MG and information of the inter-frequency measurement; and provide, to the UE, the RRC Reconfiguration message.

Item [6]: The system according to item [5], wherein the system may further include the UE, and wherein the UE may be configured to: obtain, from the RRC Reconfiguration message, the optimal MG and the information of the inter-frequency measurement; perform, based on the optimal MG and the information of the inter-frequency measurement, the inter-frequency measurement on the inter-frequency cell; and report, to the CU, the inter-frequency measurement.

Item [7]: The system according to item [6], wherein the UE may be configured to perform the inter-frequency measurement by: determining whether or not an active duration of the Cell DTX/DRX cycle associated with the inter-frequency cell is shorter than the optimal MG; and based on determining that the active duration is shorter than the optimal MG, performing the inter-frequency measurement over multiple active durations.

Item [8]: A method including: determining, based on an active duration of a Cell Discontinuous Transmission (DTX)/Discontinuous Reception (DRX) cycle associated with an inter-frequency cell, an optimal measurement gap (MG); and providing, to a user equipment (UE), information of the optimal MG, wherein the information of the optimal MG may be utilized by the UE to perform an inter-frequency measurement.

Item [9]: The method according to item [8], wherein the providing the information of the optimal MG may include: receiving, from a central unit (CU), a UE Context Setup Request message to prepare a Layer 1/Layer 2 (L1/L2) Triggered Mobility (LTM) candidate cell for the UE; and providing, to the CU, a UE Context Setup Response message comprising the information of the optimal MG.

Item [10]: The method according to item [8], wherein the providing the information of the optimal MG may include: providing, to a central unit (CU), a UE Context Modification Required message comprising the information of the optimal MG.

Item [11]: The method according to item [9], further including: generating a Radio Resource Control (RRC) Reconfiguration message comprising the information of the optimal MG and configuration of the inter-frequency cell; and providing, to the UE, the RRC Reconfiguration message.

Item [12]: The method according to item [10], further including: generating a Radio Resource Control (RRC) Reconfiguration message comprising the information of the optimal MG and information of the inter-frequency measurement; and providing, to the UE, the RRC Reconfiguration message.

Item [13]: The method according to item [12], further including: obtaining, from the RRC Reconfiguration message, the optimal MG and the information of the inter-frequency measurement; performing, based on the optimal MG and the information of the inter-frequency measurement, the inter-frequency measurement on the inter-frequency cell; and reporting, to the CU, the inter-frequency measurement.

Item [14]: The method according to item [13], wherein the performing the inter-frequency measurement may include: determining whether or not an active duration of the Cell DTX/DRX cycle associated with the inter-frequency cell is shorter than the optimal MG; and based on determining that the active duration is shorter than the optimal MG, performing the inter-frequency measurement over multiple active durations.

Item [15]: A non-transitory computer-readable recording medium having recorded thereon instructions executable by at least one network node to cause the at least one network node to perform a method including: determining, based on an active duration of a Cell Discontinuous Transmission (DTX)/Discontinuous Reception (DRX) cycle associated with an inter-frequency cell, an optimal measurement gap (MG); and providing, to a user equipment (UE), information of the optimal MG, wherein the information of the optimal MG may be utilized by the UE to perform an inter-frequency measurement.

Item [16]: The non-transitory computer-readable recording medium according to item [15], wherein the providing the information of the optimal MG may include: receiving, from a central unit (CU), a UE Context Setup Request message to prepare a Layer 1/Layer 2 (L1/L2) Triggered Mobility (LTM) candidate cell for the UE; and providing, to the CU, a UE Context Setup Response message comprising the information of the optimal MG.

Item [17]: The non-transitory computer-readable recording medium according to item [15], wherein the providing the information of the optimal MG may include: providing, to a central unit (CU), a UE Context Modification Required message comprising the information of the optimal MG.

Item [18]: The non-transitory computer-readable recording medium according to item [16], wherein the method may further include: generating a Radio Resource Control (RRC) Reconfiguration message comprising the information of the optimal MG and configuration of the inter-frequency cell; and providing, to the UE, the RRC Reconfiguration message.

Item [19]: The non-transitory computer-readable recording medium according to item [16], wherein the method may further include: generating a Radio Resource Control (RRC) Reconfiguration message comprising the information of the optimal MG and information of the inter-frequency measurement; and providing, to the UE, the RRC Reconfiguration message.

Item [20]: The non-transitory computer-readable recording medium according to item [19], wherein the method may further including, further including: obtaining, from the RRC Reconfiguration message, the optimal MG and the information of the inter-frequency measurement; performing, based on the optimal MG and the information of the inter-frequency measurement, the inter-frequency measurement on the inter-frequency cell; and reporting, to the CU, the inter-frequency measurement.

Item [21]: A distributed unit (DU) that may be configured to: provide, to a user equipment (UE), at least one uplink (UL) grant for communicating with the DU; and receive, from the UE during a non-active duration of a Cell Discontinuous Transmission (DTX)/Discontinuous Reception (DRX) cycle associated with a target cell, at least one notification of a successful Layer 1 (L1)/Layer 2 (L2) Triggered Mobility (LTM) cell switch from a serving cell to the target cell.

Item [22]: The DU according to item [21], wherein the at least one UL grant may include a dynamic scheduling grant.

Item [23]: The DU according to any one of items [21]-[22], wherein the at least one UL grant may include a pre-configured grant.

Item [24]: The DU according to any one of items [21]-[23], wherein the DU may be configured to receive the notification of the successful LTM cell switch by: receiving, from the UE, a Media Access Control (MAC) Control Element (CE).

Item [25]: The DU according to any one of items [21]-[24], wherein the DU may be configured to receive the notification of the successful LTM cell switch by: receiving, from the UE, a control Protocol Data Unit (PDU).

Item [26]: The DU according to items [23], wherein the DU may be configured to provide the at least one UL grant by: obtaining, from the target cell, information of the pre-configured grant; generating a Random Access Response (RAR) message to include the information of the pre-configured grant; and providing, to the UE via a Physical Downlink Control Channel (PDCCH), the RAR message.

Item [27]: A method including: providing, to a user equipment (UE), at least one uplink (UL) grant for communicating with a distributed unit (DU); and receiving, from the UE during a non-active duration of a Cell Discontinuous Transmission (DTX)/Discontinuous Reception (DRX) cycle associated with a target cell, at least one notification of a successful Layer 1 (L1)/Layer 2 (L2) Triggered Mobility (LTM) cell switch from a serving cell to the target cell.

Item [28]: The method according to item [27], wherein the at least one UL grant may include a dynamic scheduling grant.

Item [29]: The method according to any one of items [27]-[28], wherein the at least one UL grant may include a pre-configured grant.

Item [30]: The method according to any one of items [27]-[29], wherein the receiving the notification of the successful LTM cell switch may include: receiving, from the UE, a Media Access Control (MAC) Control Element (CE).

Item [31]: The method according to any one of items [27]-[30], wherein the receiving the notification of the successful LTM cell switch may include: receiving, from the UE, a control Protocol Data Unit (PDU).

Item [32]: The method according to items [29], wherein the providing the UL grant may include: obtaining, from the target cell, information of the pre-configured grant; generating a Random Access Response (RAR) message to include the information of the pre-configured grant; and providing, to the UE via a Physical Downlink Control Channel (PDCCH), the RAR message.

Item [33]: A non-transitory computer-readable recording medium having recorded thereon instructions executable by a distributed unit (DU) to cause the DU to perform a method including: providing, to a user equipment (UE), at least one uplink (UL) grant for communicating with the DU; and receiving, from the UE during a non-active duration of a Cell Discontinuous Transmission (DTX)/Discontinuous Reception (DRX) cycle associated with a target cell, at least one notification of a successful Layer 1 (L1)/Layer 2 (L2) Triggered Mobility (LTM) cell switch from a serving cell to the target cell.

Item [34]: The non-transitory computer-readable recording medium according to item [33], wherein the at least one UL grant may include a dynamic scheduling grant.

Item [35]: The non-transitory computer-readable recording medium according to any one of items [33]-[34], wherein the at least one UL grant may include a pre-configured grant.

Item [36]: The non-transitory computer-readable recording medium according to any one of items [33]-[35], wherein the receiving the notification of the successful LTM cell switch may include: receiving, from the UE, a Media Access Control (MAC) Control Element (CE).

Item [37]: The non-transitory computer-readable recording medium according to any one of items [33]-[36], wherein the receiving the notification of the successful LTM cell switch may include: receiving, from the UE, a control Protocol Data Unit (PDU).

Item [38]: The non-transitory computer-readable recording medium according to item [35], wherein the providing the UL grant may include: obtaining, from the target cell, information of the pre-configured grant; generating a Random Access Response (RAR) message to include the information of the pre-configured grant; and providing, to the UE via a Physical Downlink Control Channel (PDCCH), the RAR message.

Item [39]: A system including a central unit (CU) configurable to: receive, from a first Distributed Unit (DU) associated with a serving cell, energy saving configuration of a target cell; determine, based on the energy saving configuration, whether or not Cell Discontinuous Transmission (DTX)/Discontinuous Reception (DRX) has been enabled at the target cell; and based on determining that the Cell DTX/DRX has been enabled at the target cell, provide, to a second DU associated with the target cell, an instruction to deactivate the Cell DTX/DRX of the target cell for a predefined period of time.

Item [40]: The system according to item [39], wherein the CU may be further configured to: receive, from the second DU prior to the receiving of the energy saving configuration, a UE Context Modification Required message including a Cell Identity (ID) and Timing Advance (TA) of the target cell; and provide, to the first DU, a Downlink (DL) Radio Resource Control (RRC) Message Transfer message including the Cell ID and the TA of the target cell.

Item [41]: The system according to item [40], wherein the system may further include the first DU, and wherein the first DU may be configured to: receive, from the CU, the DL RRC Message Transfer message; provide, to a user equipment (UE), an RRC Reconfiguration message including the Cell ID and the TA of the target cell; receive, from the UE, at least one Layer 1 (L1) measurement of the target cell, wherein the at least one L1 measurement may include the energy saving configuration of the target cell; and provide, to the CU via F1 interface, a message including the energy saving configuration of the target cell.

Item [42]: The system according to item [41], wherein the system may further include the UE, and wherein the UE may be configured to: perform a Layer 1 (L1)/Layer 2 (L2) Triggered Mobility (LTM) cell switch from the serving cell to the target cell; and provide, to the second DU upon a successful LTM cell switch, an uplink (UL) data packet.

Item [43]: A method including: receiving, from a first Distributed Unit (DU) associated with a serving cell, energy saving configuration of a target cell; determining, based on the energy saving configuration, whether or not Cell Discontinuous Transmission (DTX)/Discontinuous Reception (DRX) has been enabled at the target cell; and based on determining that the Cell DTX/DRX has been enabled at the target cell, providing, to a second DU associated with the target cell, an instruction to deactivate the Cell DTX/DRX of the target cell for a predefined period of time.

Item [44]: The method according to item [43], further including: receiving, from the second DU prior to the receiving of the energy saving configuration, a UE Context Modification Required message including a Cell Identity (ID) and Timing Advance (TA) of the target cell; and providing, to the first DU, a Downlink (DL) Radio Resource Control (RRC) Message Transfer message including the Cell ID and the TA of the target cell.

Item [45]: The method according to item [44], further including: receiving, from the CU, the DL RRC Message Transfer message; providing, to a user equipment (UE), an RRC Reconfiguration message including the Cell ID and the TA of the target cell; receiving, from the UE, at least one Layer 1 (L1) measurement of the target cell, wherein the at least one L1 measurement may include the energy saving configuration of the target cell; and provide, to the CU via F1 interface, a message including the energy saving configuration of the target cell.

Item [46]: The method according to item [45], further including: performing a Layer 1 (L1)/Layer 2 (L2) Triggered Mobility (LTM) cell switch from the serving cell to the target cell; and providing, to the second DU upon a successful LTM cell switch, an uplink (UL) data packet.

Item [47]: A non-transitory computer-readable recording medium having recorded thereon instructions executable by at least one network node to cause the at least one network node to perform a method including: receiving, from a first Distributed Unit (DU) associated with a serving cell, energy saving configuration of a target cell; determining, based on the energy saving configuration, whether or not Cell Discontinuous Transmission (DTX)/Discontinuous Reception (DRX) has been enabled at the target cell; and based on determining that the Cell DTX/DRX has been enabled at the target cell, providing, to a second DU associated with the target cell, an instruction to deactivate the Cell DTX/DRX of the target cell for a predefined period of time.

Item [48]: The non-transitory computer-readable recording medium according to item [47], wherein the method may further include: receiving, from the second DU prior to the receiving of the energy saving configuration, a UE Context Modification Required message including a Cell Identity (ID) and Timing Advance (TA) of the target cell; and providing, to the first DU, a Downlink (DL) Radio Resource Control (RRC) Message Transfer message including the Cell ID and the TA of the target cell.

Item [49]: The non-transitory computer-readable recording medium according to item [48], wherein the method may further include: receiving, from the CU, the DL RRC Message Transfer message; providing, to a user equipment (UE), an RRC Reconfiguration message including the Cell ID and the TA of the target cell; receiving, from the UE, at least one Layer 1 (L1) measurement of the target cell, wherein the at least one L1 measurement may include the energy saving configuration of the target cell; and provide, to the CU via F1 interface, a message including the energy saving configuration of the target cell.

Item [50]: The non-transitory computer-readable recording medium according to item [49], wherein the method may further include: performing a Layer 1 (L1)/Layer 2 (L2) Triggered Mobility (LTM) cell switch from the serving cell to the target cell; and providing, to the second DU upon a successful LTM cell switch, an uplink (UL) data packet.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a distributed unit (DU) configured to:
determine, based on an active duration of a Cell Discontinuous Transmission (DTX)/Discontinuous Reception (DRX) cycle associated with an inter-frequency cell, an optimal measurement gap (MG); and
provide, to a user equipment (UE), information of the optimal MG, wherein the information of the optimal MG is utilized by the UE to perform an inter frequency measurement.

2. The system according to claim 1,
wherein the DU is configured to provide the information of the optimal MG by:
receiving, from a central unit (CU), a UE Context Setup Request message to prepare a Layer 1/Layer 2 (L1/L2) Triggered Mobility (LTM) candidate cell for the UE; and
providing, to the CU, a UE Context Setup Response message comprising the information of the optimal MG.

3. The system according to claim 1,
wherein the DU is configured to provide the information of the optimal MG by:
providing, to a central unit (CU), a UE Context Modification Required message comprising the information of the optimal MG.

4. The system according to claim 2,
wherein the system further comprises the CU, and
wherein the CU is configured to:
generate a Radio Resource Control (RRC) Reconfiguration message comprising the information of the optimal MG and configuration of the inter-frequency cell; and
provide, to the UE, the RRC Reconfiguration message.

5. The system according to claim 3,
wherein the system further comprises the CU, and
wherein the CU is configured to:
generate a Radio Resource Control (RRC) Reconfiguration message comprising the information of the optimal MG and information of the inter-frequency measurement; and
provide, to the UE, the RRC Reconfiguration message.

6. The system according to claim 5,
wherein the system further comprises the UE, and
wherein the UE is configured to:
obtain, from the RRC Reconfiguration message, the optimal MG and the information of the inter-frequency measurement;
perform, based on the optimal MG and the information of the inter-frequency measurement, the inter-frequency measurement on the inter-frequency cell; and
report, to the CU, the inter-frequency measurement.

7. The system according to claim 6,
wherein the UE is configured to perform the inter-frequency measurement by:
determining whether or not an active duration of the Cell DTX/DRX cycle associated with the inter-frequency cell is shorter than the optimal MG; and
based on determining that the active duration is shorter than the optimal MG, performing the inter-frequency measurement over multiple active durations.

8. A method comprising:
determining, based on an active duration of a Cell Discontinuous Transmission (DTX)/Discontinuous Reception (DRX) cycle associated with an inter-frequency cell, an optimal measurement gap (MG); and
providing, to a user equipment, information of the optimal MG, wherein the information of the optimal MG is utilized by the UE to perform an inter-frequency measurement.

9. The method according to claim 8,
wherein the providing the information of the optimal MG comprises:
receiving, from a central unit (CU), a UE Context Setup Request message to prepare a Layer 1/Layer 2 (L1/L2) Triggered Mobility (LTM) candidate cell for the UE; and
providing, to the CU, a UE Context Setup Response message comprising the information of the optimal MG.

10. The method according to claim 8,
wherein the providing the information of the optimal MG comprises:
providing, to a central unit (CU), a UE Context Modification Required message comprising the information of the optimal MG.

11. The method according to claim 9, further comprising:
generating a Radio Resource Control (RRC) Reconfiguration message comprising the information of the optimal MG and configuration of the inter-frequency cell; and
providing, to the UE, the RRC Reconfiguration message.

12. The method according to claim 10, further comprising:
generating a Radio Resource Control (RRC) Reconfiguration message comprising the information of the optimal MG and information of the inter-frequency measurement; and
providing, to the UE, the RRC Reconfiguration message.

13. The method according to claim 12, further comprising:
obtaining, from the RRC Reconfiguration message, the optimal MG and the information of the inter-frequency measurement;
performing, based on the optimal MG and the information of the inter-frequency measurement, the inter-frequency measurement on the inter-frequency cell; and
reporting, to the CU, the inter-frequency measurement.

14. The method according to claim 13,
wherein the performing the inter-frequency measurement comprises:
determining whether or not an active duration of the Cell DTX/DRX cycle associated with the inter-frequency cell is shorter than the optimal MG; and
based on determining that the active duration is shorter than the optimal MG, performing the inter-frequency measurement over multiple active durations.

15. A non-transitory computer-readable recording medium having recorded thereon instructions executable by at least one network node to cause the at least one network node to perform a method comprising:
determining, based on an active duration of a Cell Discontinuous Transmission (DTX)/Discontinuous Reception (DRX) cycle associated with an inter-frequency cell, an optimal measurement gap (MG); and
providing, to a user equipment (UE), information of the optimal MG, wherein the information of the optimal MG is utilized by the UE to perform an inter frequency measurement.
